(19) United States
(12) Patent Application Publication
(10) Pub. No.: US 2026/0205174 A1
(43) Pub. Date: Jul. 16, 2026

(54) REPEATER SIGNAL PATTERN AS ASSISTING INFORMATION

(71) Applicant: LENOVO (SINGAPORE) PTE. LTD., Singapore (SG)

(72) Inventors: Seyedomid Taghizadeh Motlagh, Oberursel (DE); Ali Ramadan Ali, Kraiburg (DE); Robin Rajan Thomas, Bad Nauheim (DE); Soumya Somasekharan Nambiar, Aachen (DE)

(73) Assignee: Lenovo (Singapore) Pte. Limited, Singapore (SG)

(21) Appl. No.: 19/133,184

(22) PCT Filed: Nov. 16, 2023
(86) PCT No.: PCT/IB2023/061613

§ 371 Date: May 27, 2025

Related U.S. Application Data
(60) Provisional application No. 63/428,295, filed on Nov. 28, 2022.

(51) Int. Cl. H04B 7/06; H04B 7/04; H04L 25/02

(52) U.S. Cl. CPC H04B 7/0617; H04L 25/0226; H04B 7/04013

(57) ABSTRACT

Various aspects of the present disclosure relate to an apparatus for repeater signal pattern as assisting information. The apparatus, such as a receiving device (e.g., a UE) receives a first signaling indicating a receive configuration for reception of a reference signal, and receives a second signaling indicating estimated signal configuration information including a propagation pattern attributable to a repeater device. The receiving device receives the reference signal according to the receive configuration, and receives a third signaling indicating measurement of the reference signal based at least in part on the estimated signal configuration information.

### RELATED APPLICATION

This application claims priority to U.S. Provisional Application Ser. No. 63/428,295 filed Nov. 28, 2022 entitled “Repeater Signal Pattern as Assisting Information,” the disclosure of which is incorporated by reference herein in its entirety.

### TECHNICAL FIELD

The present disclosure relates to wireless communications, and more specifically to repeater signal patterns.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A reconfigurable intelligent surface (RIS) can be implemented as a repeater node and utilized to monitor environment reflections and/or to illuminate a target or area of interest for sensing. Further, a RIS as a repeater node can be deployed to assist in UE positioning when sufficient line-of-sight (LOS) link measurements do not exist between the UE and capable radio access network (RAN) nodes. However, the incident rays reflected and/or forwarded by a RIS as a repeater node can experience non-deterministic and/or unequal propagation delay and angular spread, leading to inaccuracies.

### SUMMARY

The present disclosure relates to methods, apparatuses, and systems that support repeater signal pattern as assisting information. By utilizing the described techniques, a UE or other type of receiving device can utilize various aspects of a repeater signal pattern as assisting information, such as for positioning. For instance, a network entity transmits signaling indicating various configurations associated with a receiving device (e.g., a UE) that receives a reference signal. The network entity can be any one or more of a base station, a RIS, a RAN node, location management function (LMF), an integrated access and backhaul (IAB) node, a sensing controller, network management entity, or other type of network entity, or a UE that configures a positioning and/or sensing operation in the sidelink non-connected mode. For example, the network entity transmits and the receiving device receives a configuration for reception of a reference signal by the device. The network entity also transmits and the device receives estimated signal configuration information that includes a propagation delay pattern and/or an angular pattern attributable to a repeater device. The receiving device receives a reference signal according to the receive configuration, and the network entity transmits and the device receives a signaling indicating measurement of the reference signal based on the estimated signal configuration information. By utilizing aspects of the repeater signal pattern as assisting information, a receiving device can further refine high accuracy positioning, monitor environment signal reflections, and/or obtain coverage in areas that may not otherwise have coverage for wireless communications.

In some implementations of the method and apparatuses described herein, an apparatus, such as a base station, a RIS, a RAN node, LMF, IAB node, sensing controller, network management entity, a UE that configures positioning and/or sensing, or any other type of network entity transmits a first signaling indicating a receive configuration for reception of a reference signal by a receiving device. The apparatus transmits, to the receiving device, a second signaling indicating estimated signal configuration information including a propagation pattern of the reference signal attributable to one or more repeater devices. The apparatus transmits, to the receiving device, a third signaling indicating a measurement configuration of the reference signal received according to the receive configuration and based on the estimated signal configuration information.

Some implementations of the method and apparatuses described herein may further include the propagation pattern of the reference signal includes a delay pattern, an angular pattern, a time pattern, a phase shift pattern, and/or an amplification pattern attributable to the one or more repeater devices. The apparatus transmits, to the receiving device, a fourth signaling indicating a configuration to obtain the estimated signal configuration information, which includes time-frequency resources for receiving propagation pattern information, one or more of data types or data type values associated with the propagation pattern information, and/or a data format associated with the propagation pattern information. The data types include a delay value (e.g., 30 nsec) indicating a fixed delay and/or an average delay caused by a reflection or an amplification of the reference signal at the one or more repeater devices; a range of delay values (e.g., 15-30 nsec) associated with the reflection or the amplification of the reference signal from the one or more repeater devices; a delay spread or a delay variance associated with the reflection or the amplification of the reference signal from the one or more repeater devices; a probability mass function indicating a delay pattern caused by the one or more repeater devices; at least one of one or more angle values, an angular value range, or a probability mass function over multiple angle values of the reference signal according to a coordinate system associated with the one or more repeater devices (e.g., −10, 10 degrees of angular mismatch in the zenith direction with a uniform probability caused by the reflection, angular rotation, or angular noise or mismatch at a repeater device); at least one of energy values or amplification values of the reference signal associated with respective delay points and the one or more angle values; and/or a joint pattern of delay, angle, or energy associated with the one or more repeater devices (e.g., an angular shift of 10 degrees in the zenith direction for a propagation path with an induced delay of 15 nsec due to a repeater device operation). The data types include reciprocity mismatch information of at least one repeater device of the one or more repeater devices, the reciprocity mismatch information indicating a time period (e.g., from an indication point until 10 sec) for which the propagation pattern remains valid; at least one of a reception, incident angle, or angular region for which the propagation pattern remains valid (e.g., for incident waves with the azimuth angle of 0-60 degrees); and/or a difference between for a time period and an angular region (e.g., statistics of the repeater delay difference between two time segments and/or two reception or incident angular region as an expected difference and a variance of the difference). The data types include dimensions of a repeater device of the one or more repeater devices, location information indicating a location of the repeater device, information indicating a shape of the repeater device, and/or an orientation of the repeater device. A repeater device of the one or more repeater devices is a RIS and the data types include dimensions of the RIS, a quantity of reflector elements of the RIS, and/or arrangement information indicating positioning of the reflector elements, the arrangement information including element spacing of the reflector elements. The data types include a channel phase shift pattern, an amplitude modification pattern, and/or multiple time patterns associated with the channel phase shift pattern or the amplitude modification pattern.

Some implementations of the method and apparatuses described herein may further include the receive configuration for the reception of the reference signal includes a location and/or a velocity of a transmitter device; a transmission radiation pattern of the transmitter device; a waveform type of the reference signal and/or a set of waveform-defining parameters according to which the reference signal is transmitted; a set of resources over which the reference signal is transmitted according to the waveform type and/or the set of waveform-defining parameters; a transmit power according to which the reference signal is transmitted; and/or a sequence generation and physical-resource-mapping type based on which the reference signal is generated. The measurement configuration includes a time-of-arrival (ToA) estimation or a time-of-flight (ToF) estimation; a direction-of-arrival (DoA) estimation and/or an angle-of-arrival (AoA) estimation; an estimated time-difference-of-arrival (TDOA) for a signal path associated with a repeater device of the one or more repeater devices and another indicated signal path; and/or an estimated relative angle of the signal path to the repeater device.

Some implementations of the method and apparatuses described herein may further include the apparatus transmits, to the one or more repeater devices, a signaling indicating a signal generating configuration that includes a delay pattern, an angular pattern, a time pattern, and/or a phase shift pattern associated with a delay, angle, and/or phase shift of a transmitted signal. The measurement configuration includes a determined LOS condition and/or a non-line-of-sight (NLOS) condition of a propagation path, an association of the propagation path or a channel state information (CSI) measurement to a repeater device of the one or more repeater devices or to a path not associated to the repeater device, an association of the propagation path or a CSI measurement to the repeater device, and/or the association of the propagation path or the CSI measurement to a path not associated with the repeater device, based on the phase shift of the transmitted signal, an amplitude modification pattern, and/or multiple time patterns associated with phase shift patterns and amplitude patterns of the one or more repeater devices.

Some implementations of the method and apparatuses described herein may further include the estimated signal configuration includes a threshold of a received power value and/or received power measurements. The measurement configuration includes a CSI estimation of a propagation path associated with a repeater device of the one or more repeater devices, a type of the CSI estimation of the propagation path, an indication of a detected object, a first estimation of a device position and/or a device velocity, and/or a second estimation of an object position, an object velocity, and/or an object size. A repeater device of the one or more repeater devices is a network-controlled repeater, multiple network-controlled repeaters, a RIS, an IAB node, a sidelink relay node (e.g., a repeater dedicated to a sidelink connection, or a UE operating as a SL repeater for a set of time-frequency resources), and/or a reflector object. The apparatus transmits a signaling indicating a reference signal transmission configuration to the receiving device, where the reference signal transmission configuration includes a waveform type of the reference signal and/or a set of waveform-defining parameters according to which the reference signal is transmitted; a set of resources over which the reference signal is transmitted according to the waveform type and/or the set of waveform-defining parameters; a transmit beam pattern and/or a radiation pattern over which the reference signal is transmitted; a transmit power according to which the reference signal is transmitted; and/or a sequence generation and physical-resource-mapping type based on which the reference signal is generated. The apparatus transmits, to the receiving device, a signaling indicating a reporting configuration that includes a set of time-frequency and beam resources for transmission of a report, a criterion for the transmission of the report, and/or an information type included in the report.

Some implementations of the method and apparatuses described herein may further include the apparatus is one of a next-generation NodeB (gNB), a road-side unit (RSU), a UE, a location server, or a sensing controller device. The apparatus transmits a signaling indicating a request for information of an induced propagation pattern that includes a delay-angular pattern, a delay pattern, an angular pattern, and/or a phase shift pattern from the one or more repeater devices. The apparatus receives, from the one or more repeater devices, a signaling of the information including the induced propagation pattern of the one or more delay-angular pattern, the delay pattern, the angular pattern, and/or the phase shift pattern. The apparatus transmits, to the receiving device, a signaling indicating a reception configuration to obtain the propagation pattern of the reference signal of the one or more repeater devices; transmits, to the receiving device, a signaling indicating an operational state of the one or more repeater devices; and transmits, to the receiving device, a signaling indicating a signal measurement of a delay pattern and angle pattern of the one or more repeater devices. The apparatus receives a signaling as a report of the signal measurement of the delay pattern and the angle pattern of the one or more repeater devices.

In some implementations of the method and apparatuses described herein, an apparatus, such as a UE or other type receiving device receives a first signaling indicating a receive configuration for reception of a reference signal, and receives a second signaling indicating estimated signal configuration information including a propagation pattern attributable to one or more repeater devices. The apparatus receives the reference signal according to the receive configuration, and receives a third signaling indicating a measurement configuration of the reference signal based on the estimated signal configuration information.

Some implementations of the method and apparatuses described herein may further include the propagation pattern of the reference signal includes a delay pattern, an angular pattern, a time pattern, a phase shift pattern, and/or an amplification pattern attributable to the one or more repeater devices. The apparatus receives a fourth signaling indicating a configuration to obtain the estimated signal configuration information including time-frequency resources for receiving propagation pattern information, one or more of data types or data type values associated with the propagation pattern information, and/or a data format associated with the propagation pattern information. The data types include a delay value indicating a fixed delay and/or an average delay caused by one of a reflection or an amplification of the reference signal at the one or more repeater devices; a range of delay values associated with the reflection or the amplification of the reference signal from the one or more repeater devices; a delay spread and/or a delay variance associated with the reflection or the amplification of the reference signal from the one or more repeater devices; a probability mass function indicating a delay pattern caused by the one or more repeater devices; at least one of one or more angle values, an angular value range, or a probability mass function over multiple angle values of the reference signal according to a coordinate system associated with the one or more repeater devices; at least one of energy values or amplification values of the reference signal associated with respective delay points and the one or more angle values; and/or a joint pattern of delay, angle, and energy associated with the one or more repeater devices. The data types include reciprocity mismatch information of at least one repeater device of the one or more repeater devices, the reciprocity mismatch information indicating a time period (e.g., from an indication point until 10 sec) for which the propagation pattern remains valid; at least one of a reception, incident angle, or angular region for which the propagation pattern remains valid (e.g., for incident waves with the azimuth angle of 0-60 degrees); and/or a difference between propagation patterns between two time periods, between two reception angular regions, or jointly for a time period and an angular region (e.g., statistics of the repeater delay difference between two time segments and/or two reception or incident angular region as an expected difference and a variance of the difference). The data types include dimensions of a repeater device of the one or more repeater devices, location information indicating a location of the repeater device, information indicating a shape of the repeater device, and/or an orientation of the repeater device. A repeater device of the one or more repeater devices is a RIS and the data types include dimensions of the RIS, a quantity of reflector elements of the RIS, and/or arrangement information indicating positioning of the reflector elements, the arrangement information including element spacing of the reflector elements. The data types include a channel phase shift pattern, an amplitude modification pattern, and/or multiple time patterns associated with the channel phase shift pattern and/or the amplitude modification pattern.

Some implementations of the method and apparatuses described herein may further include the receive configuration for the reception of the reference signal includes a location and/or a velocity of a transmitter device; a transmission radiation pattern of the transmitter device; a waveform type of the reference signal and/or a set of waveform-defining parameters according to which the reference signal is transmitted; a set of resources over which the reference signal is transmitted according to the waveform type and/or the set of waveform-defining parameters; a transmit power according to which the reference signal is transmitted; and/or a sequence generation and physical-resource-mapping type based on which the reference signal is generated. The measurement configuration includes a ToA estimation and/or a ToF estimation, a DoA estimation and/or an AoA estimation, an estimated TDOA for a signal path associated with a repeater device of the one or more repeater devices and another indicated signal path, and/or an estimated relative angle of the signal path to the repeater device.

Some implementations of the method and apparatuses described herein may further include the apparatus receives, from the one or more repeater devices, a signaling indicating a signal generating configuration that includes a delay pattern, an angular pattern, a time pattern, and/or a phase shift pattern associated with a delay, angle, and/or phase shift of a transmitted signal. The measurement configuration includes a determined LOS condition or a NLOS condition of a propagation path, an association of the propagation path or a CSI measurement to a repeater device of the one or more repeater devices or to a path not associated to the repeater device, an association of the propagation path or a CSI measurement to the repeater device, and/or the association of the propagation path or the CSI measurement to a path not associated with the repeater device, based on the phase shift of the transmitted signal, an amplitude modification pattern, and/or multiple time patterns associated with phase shift patterns and amplitude patterns of the one or more repeater devices.

Some implementations of the method and apparatuses described herein may further include the estimated signal configuration includes a threshold of a received power value and/or received power measurements. The measurement configuration includes a CSI estimation of a propagation path associated with a repeater device of the one or more repeater devices, a type of the CSI estimation of the propagation path, an indication of a detected object, a first estimation of a device position and/or a device velocity, and/or a second estimation of an object position, an object velocity, and/or an object size. The repeater device is a network-controlled repeater, multiple network-controlled repeaters, a RIS, an IAB node, a sidelink relay node (e.g., a repeater dedicated to a sidelink connection, or a UE operating as a SL repeater for a set of time-frequency resources), and/or a reflector object. The apparatus receives a signaling indicating a reference signal transmission configuration for a receiving device, the reference signal transmission configuration including a waveform type of the reference signal and/or a set of waveform-defining parameters according to which the reference signal is transmitted; a set of resources over which the reference signal is transmitted according to the waveform type and/or the set of waveform-defining parameters; a transmit beam pattern and/or a radiation pattern over which the reference signal is transmitted; a transmit power according to which the reference signal is transmitted; and/or a sequence generation and physical-resource-mapping type based on which the reference signal is generated.

Some implementations of the method and apparatuses described herein may further include the apparatus receives a signaling indicating a reporting configuration that includes a set of time-frequency and beam resources for transmission of a report, a criterion for the transmission of the report, and/or an information type included in the report. The apparatus receives a signaling indicating a reception configuration to obtain the propagation pattern of the reference signal of the one or more repeater device; receives a signaling indicating an operational state of the one or more repeater devices; and receives a signaling indicating a signal measurement of a delay pattern and angle pattern of the one or more repeater devices. The apparatus transmits a signaling as a report of the signal measurement of the delay pattern and the angle pattern of the one or more repeater devices.

### BRIEF DESCRIPTION OF THE DRAWINGS

FIG. 1 illustrates an example of a wireless communications system that supports repeater signal pattern as assisting information in accordance with aspects of the present disclosure.

FIG. 2 illustrates examples of RIS impact on the ToF that is experienced at a receiver (e.g., a UE) given the rays reflected from different parts of a RIS are subject to different time-delays, as related to repeater signal pattern as assisting information in accordance with aspects of the present disclosure.

FIG. 3 illustrates examples 300 of the impact of a RIS reflection strategy on the ToF that is experienced at a receiver (e.g., a UE), as related to repeater signal pattern as assisting information in accordance with aspects of the present disclosure.

FIG. 4 illustrates examples of various sensing scenarios for sensing reference signal (RS) transmission and sensing RS reception by the network and/or devices, as related to repeater signal pattern as assisting information in accordance with aspects of the present disclosure.

FIG. 5 illustrates an example of a gNB-RIS control air interface, as related to repeater signal pattern as assisting information in accordance with aspects of the present disclosure.

FIGS. 6 and 7 illustrate an example of a block diagram of devices that supports repeater signal pattern as assisting information in accordance with aspects of the present disclosure.

FIGS. 8-13 illustrate flowcharts of methods that support repeater signal pattern as assisting information in accordance with aspects of the present disclosure.

### DETAILED DESCRIPTION

In aspects of this disclosure, RIS evaluation scenarios are considered, such as RIS-assisted uplink throughput enhancement, as well as cell coverage improvements. The signal information of propagation delay and/or angular spread caused by a RIS as a repeater node (also referred to as a repeater controller), can be utilized at a receiver device (e.g., a UE). This disclosure provides solutions address at least how the channel delay and/or the angular spread caused by a RIS as a repeater node can be obtained at a receiver device (e.g., a UE, a sensing Rx node, or a target device for positioning), and how the information of the delay and/or angular spread caused by the RIS as a repeater node can be utilized to improve measurement results at the receiver.

A wireless communications system can include the use of RIS technology for sensing and/or high accuracy positioning for various deployments and use-cases. A RIS can be implemented as a repeater node and utilized to monitor environment reflections and/or to illuminate a target or area of interest for sensing. Further, a RIS as a repeater node can be deployed to assist in UE positioning when sufficient LOS link measurements do not exist between the UE and capable RAN nodes. Additionally, multipath and NLOS propagation are known to be detrimental to positioning performance. The RIS elements can be implemented and have the capability for phase rotation on the incident wave towards the reflected wave, thereby controlling the directional properties of reflected wave propagation. However, the incident rays reflected and/or forwarded by a RIS as a repeater node can experience non-deterministic and/or unequal propagation delay and angular spread due to various factors. For example, the potentially large deployment size of a RIS can lead to time-of-flight (TOF) ambiguity of the rays reflected from different elements and parts of the surface, which inherently impacts the time-of-arrival (ToA) at a target UE. Other factors include a dependence on the generated time-delay on the RIS topology (e.g., size, shape, and/or surface orientation); a dependence on the reflection area of the RIS towards a specific direction based on an implementation of the RIS reflection strategy (e.g., implementation of the phase rotations); and repeater delay due to the RF and/or baseband processing.

In aspects of repeater signal pattern as assisting information as described herein, a wireless communications system includes a RIS, also known as an intelligent reflecting surface (IRS), or a large intelligent surfaces (LIS), and the surface has potential to enhance the capacity and coverage of wireless networks by intelligently reconfiguring the propagation environment by adjusting the phase and the amplitude of the RIS elements of the RIS. The delay pattern and/or angular spread generated as a result of a transmitted signal experiencing a repeater and/or reflector (e.g., surface, RIS) is indicated to a receiver (e.g., a UE), either explicitly as the delay and/or angle patten information of the wireless path associated with the repeater or reflector and/or via side information (e.g., a type and shape, size, and/or geometrical information of the repeater and/or reflector entity). As such, the receiver utilizes the obtained information on the delay and/or reception angle pattern to perform measurements of a received signal such that the experienced path delay and/or angular spread is compensated (e.g., for ToF and/or ToA estimation of the repeater path, and/or DoA estimation of a repeater path). Further, the experienced path delay and/or angular pattern is reflected in the measurement reporting (e.g., the reporting of the reference signal received power (RSRP) and/or the associated delay and/or angle values for the delay and/or angle range caused by the repeater and/or reflector effect. Additionally, the path delay and/or angular pattern information is utilized to estimate features of the propagation path (e.g., the LOS condition between the received and the repeater and/or reflector, relative location of the receiver to the repeater and/or reflector).

Aspects of the present disclosure are described in the context of a wireless communications system. Aspects of the present disclosure are further illustrated and described with reference to device diagrams and flowcharts.

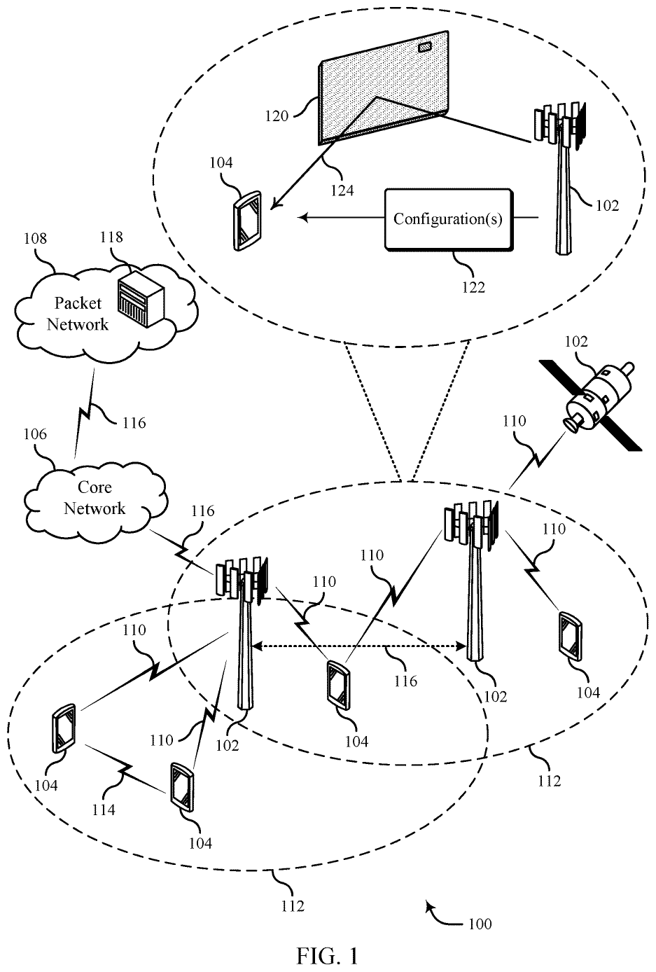

FIG. 1 illustrates an example of a wireless communications system 100 that supports repeater signal pattern as assisting information in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more Dus or Rus, and the one or more Dus or Rus may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more Rus). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more Dus via a midhaul communication link (e.g., F1, F1-c, F1-u), and a DU may be connected to one or more Rus via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHZ), FR4 (52.6 GHZ-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102, the UEs 104, and a repeater device 120 (e.g., a RIS, surface, and/or any other type of reflecting or signal forwarding device) are operable to implement various aspects of repeater signal pattern as assisting information, as described herein. For instance, a network entity 102 (e.g., a base station) transmits signaling (e.g., communicates signaling) indicating various configurations 122 associated with a receiving device (e.g., a UE 104) receiving a reference signal 124. In implementations, the network entity 102 transmits and the UE 104 receives a first signaling indicating a receive configuration for reception of a reference signal. The network entity 102 also transmits and the UE 104 receives a second signaling indicating estimated signal configuration information that includes a propagation delay pattern, an angular pattern, a time pattern, a phase shift pattern, and/or an amplification pattern attributable to one or more repeater devices. The UE 104 receives the reference signal 124 according to the receive configuration, and the network entity 102 transmits and the UE 104 receives a third signaling indicating a measurement configuration of the reference signal based on the estimated signal configuration information.

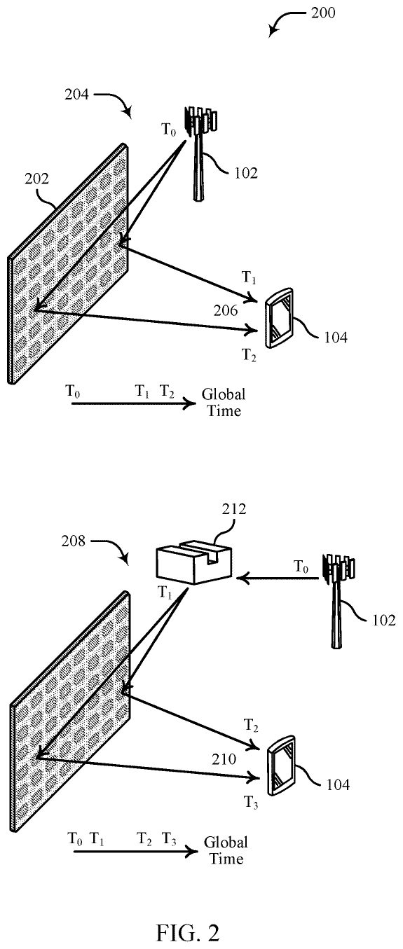

FIG. 2 illustrates examples 200 of RIS impact on the ToF that is experienced at a receiver (e.g., a UE 104) given the rays reflected from different parts of a RIS 202 are subject to different time-delays, as related to repeater signal pattern as assisting information in accordance with aspects of the present disclosure. As generally shown at 204, a UE 104 receives a transmitted signal 206 reflected from the RIS 202 (or a repeater controller) and performs ToF and/or ToA estimation for positioning. As generally shown at 208, the UE 104 receives a transmitted sensing signal 210 reflected from an object 212 and then reflected from the RIS 208 (or repeater controller). The object reflection, after a second reflection by the RIS, is received at the receiver (e.g., the UE 104). In both cases, the reflected rays (e.g., reflected signals) are subject to different ToFs depending on the reflection point and/or reflection area from the RIS. Additionally, the ray delay spread is impacted by the RIS size and/or dimension.

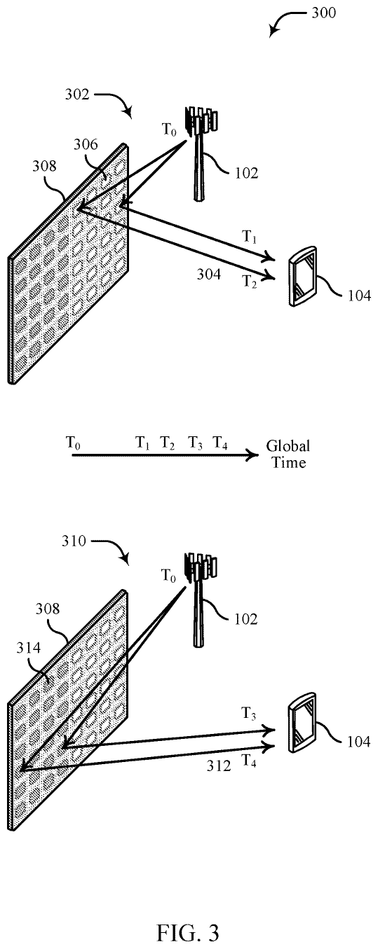

FIG. 3 illustrates examples 300 of the impact of a RIS reflection strategy on the ToF that is experienced at a receiver (e.g., a UE 104), as related to repeater signal pattern as assisting information in accordance with aspects of the present disclosure. As generally shown at 302, reflected signals 304 from a subset of RIS elements 306 of a RIS 308, and as generally shown at 310, reflected signals 312 from a different subset of RIS elements 314 of the RIS 308 are co-phased at the direction of the receiver (e.g., a UE 104). Depending on the location of the RIS elements 306 and the RIS elements 314, the receiver is subject to different ToFs of the reflected signals (also referred to as reflected rays).

In aspects of this disclosure, RIS evaluation scenarios are included, among others, considering RIS-assisted uplink throughput enhancement, as well as cell coverage improvements. An example of the resulting delay spread for the proposed evaluation scenarios are summarized in Table 1, where Δ_ToF indicates the resulting ToF ambiguity due to the RIS dimensions in terms of the baseband sampling time duration. The maximum ToF mismatch is calculated at the distance ambiguity of twice the RIS diameter.

TABLE 1
Evaluation of RIS parameters for example scenarios including uplink enhancement
and cell coverage extensions, and the resulting ToF ambiguity caused by a RIS.

| # Reflector | | | BW, Δ_{ToF} | BW, Δ_{ToF} |
|---|---|---|---|---|
| Elements | RIS Dimension | Fc | 400 MHz | 2 GHz |
| 6,400 | 42.5 cm × 42.5 cm | 28 GHz | [0-2] samples | [0-9] samples |
| 44,100 | 113 cm × 113 cm | 28 GHz | [0-5] samples | [0-22] samples |
| 90,000 | 161 cm × 161 cm | 28 GHz | [0-6] samples | [0-31] samples |
| 129,600 | 193 cm × 193 cm | 28 GHz | [0-8] samples | [0-37] samples |

Accordingly, the information of the propagation delay and/or the angular spread caused by a RIS as a repeater node (also referred to as a repeater controller), can be utilized at a receiver (e.g., a UE). This disclosure provides solutions address at least how the channel delay and/or the angular spread caused by a RIS as a repeater node can be obtained at a receiver (e.g., a UE, a sensing Rx node, or a target device for positioning), and how the information of the delay and/or angular spread caused by the RIS as a repeater node can be utilized to improve measurement results at the receiver.

With reference to radio sensing scenarios, radio sensing is considered for the cellular wireless networks, both as a mechanism to improve the network performance, as well as an enabler to serve vertical use-cases. In particular, radio sensing obtains environment information from various sources, such as from the transmission of a sensing excitation signal (e.g., a sensing RS from a network or UE entity, also termed as a sensing Tx node); from the reception of the reflections and/or echoes of the transmitted sensing excitation signal from the environment by a network or a UE entity (e.g., also termed as a sensing Rx node); and from processing of the received reflections and inferring relevant information from the environment.

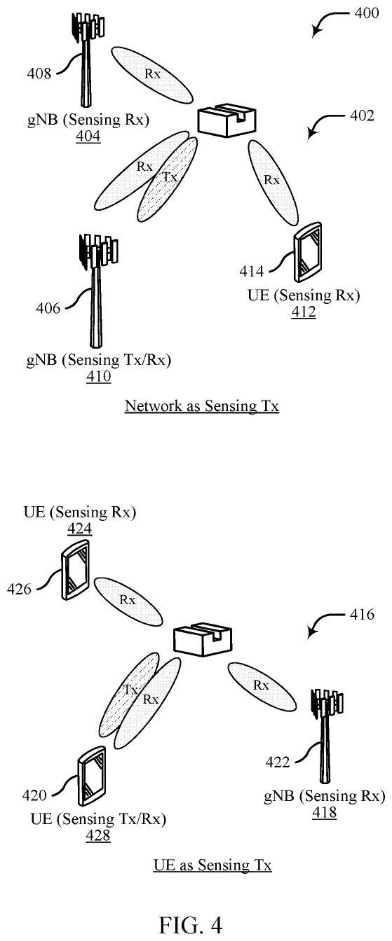

FIG. 4 illustrates examples 400 of various sensing scenarios for sensing RS transmission and sensing RS reception by the network and/or devices, as related to repeater signal pattern as assisting information in accordance with aspects of the present disclosure. The scenarios of network-based and UE-based (sidelink (SL)-based) radio sensing operations and solutions take into account radio sensing where the network configures the participating sensing entities (i.e., network and UE nodes acting as sensing Tx nodes), network and UE nodes acting as sensing Rx nodes, as well as the configuration of sensing RS, necessary measurements, and reporting procedures from the nodes. In this regard, the functional split between the network and the UE nodes for a specific sensing task may take various forms, depending on the availability of sensing-capable devices and the requirements of the specific sensing operation.

As shown at 402, a first scenario 404 includes sensing transmit (Tx) as a network node 406 (e.g., a gNB) and sensing receive (Rx) as a separate network node 408 (e.g., a gNB). In this example, the sensing RS (or another RS used for sensing or the data/control channels known to the network transmit-receive point (TRP) nodes) is transmitted and received by network the entities. The involvement of UE nodes are limited to the aspects of interference management, when necessary, and the network does not utilize UEs for sensing assistance in this scenario.

A second scenario 410 includes sensing Tx as a network node 406 (e.g., a gNB) and sensing Rx as the same network node 406. In this example, the sensing RS (or another RS used for sensing or the data/control channels known to the network TRP nodes) is transmitted and received by the same network entity. The involvement of UE nodes are limited to the aspects of interference management, when necessary, and the network does not utilize UEs for sensing assistance in this scenario.

A third scenario 412 includes sensing Tx as a network node 406 (e.g., a gNB) and sensing Rx as a UE node 414. In this example, the sensing RS or other RS used for sensing is transmitted by a network entity and received by one or multiple UE nodes (e.g., UE 414). The network configures the UEs to act as a sensing Rx node, according to the UE nodes capabilities for sensing, as well as a desired sensing task.

As shown at 416, a fourth scenario 418 includes sensing Tx as a UE 420 and sensing Rx as a network node 422 (e.g., a gNB). In this example, the sensing RS or other RS used for sensing (or a data/control channel transmitted by the UE 420) is received by one or multiple network entities and transmitted by a UE node. The network configures the UE to act as a sensing Tx node, according to the UE nodes capabilities for sensing, as well as the nature of the desired sensing task.

A fifth scenario 424 includes sensing Tx as the UE node 420 and sensing Rx as a separate UE node 426. In this example, the sensing RS or other RS used for sensing is received by one or multiple UE nodes and transmitted by a UE node. In this case, the network, or a UE node, can be implemented to determine a configuration of the sensing scenario. In one instance, the network configures the UEs to act as sensing Tx and/or sensing Rx nodes, according to the UE nodes capabilities for sensing, as well as the nature of the desired sensing task.

A sixth scenario 428 includes sensing Tx as a UE node 420 and sensing Rx as the same UE node 420. In this example, the sensing RS (or another RS used for sensing or the data/control channels known to the UE) is transmitted by a UE node and received by the same UE node. In this case, the UE or the network configures the sensing scenario, according to the UE nodes capabilities for sensing, as well as the nature of the desired sensing task.

The above described scenarios are not intended to be restricted to a specific UE type, and may include any UE category and/or functionality (e.g., a UE RSU). In any of the above scenarios, any of the roles depicted for a gNB and/or a UE may be replaced (with equal validity as an example of a radio sensing scenario) with a smart repeater node, an IAB node, or an RSU.

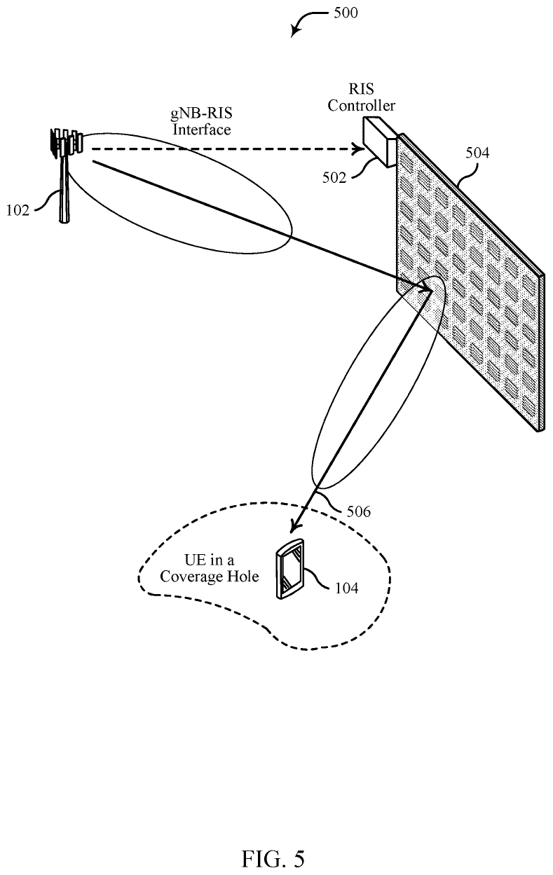

FIG. 5 illustrates an example 500 of a gNB-RIS control air interface, as related to repeater signal pattern as assisting information in accordance with aspects of the present disclosure. In this example 500, a network node 102 (e.g., a gNB) communicates with a RIS controller 502 of a RIS 504, and a UE 104 receives a signal 506 transmitted by the network node 102 and reflected from the RIS 504. With reference to RISs, also known as IRSs or LISs, the surfaces have potential to enhance the capacity and coverage of wireless networks by intelligently reconfiguring the propagation environment by adjusting the phase and the amplitude of the RIS elements. The surfaces technology for 5G+/6G wireless communication networks are cost effective since RIS technology does not require DAC/DAC (digital-to-analog converters) or power amplifiers, and hence meets green communications requirements. A RIS is made up of a large number of low-cost, passive elements that can modify radio waves impinging upon them and can be easily coated on the existing infrastructure. Further, RISs can potentially have a large impact on the design of future wireless systems, especially when integrated with other emerging and advanced technologies, such as Terahertz communication, massive multiple input, multiple output (MIMO), artificial intelligence (AI) or machine learning (ML) based systems, and the like, and can be used for different applications, such as communication, sensing, positioning, etc. To control the phases and amplitude of the RIS elements, an interface to the network is utilized to adapt the reflection characteristics of the RIS based on the channel conditions and the transmission needs.

In aspects of repeater signal pattern as assisting information as described herein, the delay pattern and/or angular spread generated as a result of a transmitted signal experiencing a repeater and/or reflector is indicated to a receiver (e.g., a UE), either explicitly as the delay and/or angle patten information of the wireless path associated with the repeater or reflector and/or via side information (e.g., a type and shape, size, and/or geometrical information of the repeater and/or reflector entity). As such, the receiver utilizes the obtained information on the delay and/or reception angle pattern to perform measurements of a received signal such that the experienced path delay and/or angular spread is compensated (e.g., for ToF and/or ToA estimation of the repeater path, and/or DoA estimation of a repeater path). Further, the experienced path delay and/or angular pattern is reflected in the measurement reporting (e.g., the reporting of the RSRP and/or the associated delay and/or angle values for the delay and/or angle range caused by the repeater and/or reflector effect. Additionally, the path delay and/or angular pattern information is utilized to estimate features of the propagation path (e.g., the LOS condition between the received and the repeater and/or reflector, relative location of the receiver to the repeater and/or reflector).

In aspects of repeater signal pattern as assisting information as described herein, receiver measurements with reflection and/or forwarding delay pattern assistance can be utilized. In an implementation, a UE is configured by the network with a first configuration for reception of a RS, a second configuration for obtaining information of the propagation delay pattern and/or angular pattern induced via a repeater entity (e.g., a RIS, a network-controlled repeater (NCR), or similar entity that reflects and/or amplifies), and a third configuration for the measurement of the received RS at the UE. As such, the UE receives the transmitted RS according to the first configuration, for which at least part of the energy of the transmitted RS is impacted by the repeater entity. The UE then obtains information on the propagation delay and/or angular pattern of the transmitted RS caused by the repeater entity, according to the received second configuration, and thereafter performs the measurement on the received RS, according to the received third configuration, based on the obtained information on the propagation delay and/or angular pattern.

In implementations, the repeater entity is a RIS, a NCR, an IAB node, or any object within the environment with known geometry and/or reflection characteristics. As such, the propagation delay effect is introduced to the transmitted RS due to the reflection of the RS from a RIS; reception and transmission or forwarding of the RS by a network-controller repeater device; reception and transmission of the RS by an IAB device; reflection of the RS from a known surface or object, and/or any combination thereof.

In implementations with reference to RS configuration, the first configuration includes any one or combination of several various configuration information, such as a waveform type or a set of waveform-defining parameters according to which the RS is transmitted; and a set of resources over which the RS is transmitted according to the indicated waveform (e.g., time-frequency resources for a cyclic-prefix orthogonal frequency-division multiplexing (CP-OFDM) waveform, time and/or frequency offset with respect to a reference time and/or frequency point, an associated periodicity of the RS, an indication on whether the RS is to be repeated, such as defining a set of repetitions, comb-size, number of symbols, a Tx beam or radiation pattern (e.g., beam direction, beam angle, beam width) over which the RS is transmitted). Additional configuration information includes transmit power according to which the RS is transmitted; the sequence generation and physical-resource-mapping type based on which the RS signal is generated; a location of the transmitter node, and/or any combination thereof.

In implementations, the second configuration for obtaining the propagation delay pattern includes an indication of delay information type and a set of time-frequency resources for receiving the information, the coding, and/or a quantization strategy of the delay information. In an implementation, the UE is indicated to receive the delay information via indicated resource elements (Res) of the NR slot and/or frame from the gNB or another RAN node, according to an indicated modulation coding scheme (MCS), where the information includes a quantized version of a fixed delay introduced via an NCR as well as the delay range according to which the rays influenced by the NCR experience different propagation values.

In some implementations, the information of the delay and/or angular pattern caused by a repeater entity can include any one or combination of several information, including a delay value as a delay (fixed or average) caused by the reflection or amplification at the repeater entity (e.g., a processing delay at an RF repeater); a delay range associated with the reflection or amplification from the repeater entity (e.g., a range of 1-3 nsec of delay caused by the reflection from the RIS; a delay spread and/or delay variance associated with the reflection or amplification from the repeater entity (e.g., a 1 nsec (rms) of delay caused by the reflection from the RIS); a probability mass function, or a quantized and/or compressed version thereof describing the delay caused by the repeater entity; one or multiple angle values (e.g., direction-of-arrival (DoA) and/or angle-of-arrival (AoA) values at the receiver) according to a global or local coordinate system; angular variance, expected angle value, angular range, a probability mass function, or a quantized and/or compressed version thereof describing the angular shift or pattern caused by the repeater entity, according to a global or known local coordinate system to the receiver.

The information of the delay and/or angular pattern caused by a repeater entity can also include any one or combination of a reflection strategy and/or characteristics (e.g., an element phase shift pattern, a mapping of the incident angle and the reflected angles and/or the associated angular energy) of a RIS and/or a time-pattern (e.g., which symbols) for which the reflection characteristic holds; an amplification strategy and/or characteristics of a NCR and/or a time-pattern (e.g., which symbols) for which the amplification characteristic holds; energy or power values and/or distribution associated with the different delay points and/or different angles (e.g., single estimation based on the collective impact of the delay-angle pattern, such as by taking a weighted average, or multiple estimations corresponding to separately observed values); area size and/or dimensions of the antenna and/or element array(s) of a repeater entity (e.g., RIS size, dimensions of a RIS, and dimensions of a known reflecting object); the channel phase and/or amplitude filliping or modification pattern over time implemented for one or multiple RIS, a group of RIS elements, a repeater channel, repeater amplification, or any combination thereof, such as by modifying the experienced phase shift of multiple RIS and/or multiple repeater entities, each according to a specific time-pattern and phase shift pattern, the channel of each RIS and/or repeater entity can be separate from other repeater entities and/or other reflective paths from a transmitter to a receiver; location information of the repeater entity (e.g., a 2D or 3D position of a RIS, a latitude and/or longitude or any other geodesic coordinates, geographical regional information, such as cell-ID, zone-ID, mobility information such as speed and/or velocity (in the case of mobile RIS), confidence interval and/or uncertainty information of the location information, or the like); an orientation of the repeater entity (e.g., orientation of the RIS according to which of the reflecting elements are placed, in relative directions in terms of the local coordinate system (LCS) and/or global coordinate system (GCS) with respect to other network entities such as a gNB, UE, etc.); an element spacing and/or number of reflector elements at the RIS and/or arrangement of the reflector elements at the RIS; and/or an impairments condition at the RIS or repeater node (e.g., additive noise level, additive noise correlation in time and/or in space (among different elements/antennas), the phase or phase rotation noise, and/or an index representing a specific impairments class.

In implementations, a network entity transmits a signaling indicating a configuration to obtain the estimated signal configuration information, which includes time-frequency resources for receiving delay pattern information and angle pattern information. The estimated signal configuration information also includes data types associated with the delay pattern information and the angle pattern information (e.g., as a vector of delay values or a delay range, a vector of power values, a vector of angle values or an angle range in azimuth and/or elevation with respect to a time reference, and a global or local coordinate system). The estimated signal configuration information also includes a data format associated with the delay pattern information and the angle pattern information (e.g., quantization steps and a number of steps, for a compression type of the information). The data types include dimensions of the repeater device (e.g., RIS size, dimensions of a RIS, dimensions of a known reflecting object), location information indicating a location of the repeater device (e.g., 2D/3D position of a RIS, latitude and/or longitude or any other geodesic coordinates, geographical regional information, such as cell-ID, zone-ID, mobility information such as speed and/or velocity (in case of mobile RIS), confidence interval or uncertainty information of the location information, or the like), and/or an orientation of the repeater device (e.g., orientation of the RIS according to which the reflecting elements are placed, relative directions in terms of the LCS and/or GCS with respect to other network entities, such as gNB, UE, etc.). The repeater device is a RIS and the data types include dimensions of the RIS, a quantity of reflector elements of the RIS, and/or arrangement information indicating positioning of the reflector elements, the arrangement information including element spacing of the reflector elements (e.g., positions of the reflecting elements, and positions of the element rows and/or columns).

In some implementations, one or multiple of the above information elements are obtained via measurements at a first receiver node (e.g., based on the CSI measurements of the first receiver channel when a repeater entity is not present and the CSI measurements of the first receiver channel when the repeater entity is present) and reported to the network and/or a second receiver node. In some implementations, one or multiple of the above information elements are indicated via an index from a codebook, where the codebook includes different conditions of the delay-angle pattern generated by the repeater entity. In an implementation, the reflection point of an RS transmission at a RIS is calculated based on the position of the RS transmitter, the direction of the Tx beam, the position of the RIS and the orientation of the RIS surface, the element arrangement and reflection or phase rotation strategy at the RIS, or any combination thereof. The obtained position of the reflection is then used for calculating the expected delay and/or angle of the propagation path.

In implementations, the measurement configuration includes the CSI estimation of the propagation path associated with the repeater entity (e.g., the UE utilizes the delay information as a side information to perform CSI measurement or the UE utilizes the delay information for the purpose of demodulation of the received downlink (DL) data and control channel via the repeater entity). The delay pattern can be used for CSI estimation of the single path (e.g., for compensating the frequency selectivity caused due to the delay spread and/or to intelligently configure or utilize the demodulation reference signal (DMRS) for demodulation). The measurement configuration can also include a ToA and/or ToF estimation (e.g., the UE estimates the ToF and/or ToA considering the delay spread generated due to the repeater entity) by estimating the ToF as the average delay, mean or expected delay normalized to the RSRP at the corresponding delay or medium delay. The measurement configuration can also include a ToF and/or ToA estimation of multiple paths (e.g., the UE estimates and obtains the ToF and/or ToA associated with all or multiple of the received rays or paths from the repeater entity, where each path can be characterized with an amplitude, delay, or the like.

In another implementation, the UE can be configured to estimate N configure paths of a total of M received paths. The path ToF measurement is not limited to only one delay tap. The measurement configuration can also include a TDOA estimation at a path associated with the repeater entity and another indicated path (e.g., perform measurements corresponding to one or multiple estimates of the difference of a pair of ToAs at a LOS path from another UE, or a gNB or RAN node and the path associated with the repeater entity. The ToA and/or ToF estimation can be either a single estimation based on the collective impact of the delay-angle pattern (e.g., by taking a weighted average), or multiple estimations corresponding to separately observed values. Similarly, the DoA and/or AoA estimation can be either a single estimation based on the collective impact of the delay-angle pattern (e.g., by taking a weighted average), or multiple estimations corresponding to separately observed values. The measurement configuration can also include a RS reception time estimation (can also be used for round-trip time (RTT)) (e.g., the UE estimates the reception time of the transmitted RS, according to an indicated criteria). In implementations, the criteria for the estimate of the RS reception is the time of the RS reception corresponding to the first received RS (path from the repeater entity with the smallest delay), the last received RS, or an average time of the received RS (i.e., an average over the estimated time for all received RSs). Moreover, the reception time can be defined with respect to a beginning, end, or an indicated reference point (middle) within the defined RS.

The measurement configuration can also include a LOS and/or NLOS determination (e.g., the UE determines the LOS condition from the repeater entity towards the UE path, the gNB or base station towards the repeater entity path, according to the measured RS delay and/or angular pattern in comparison to the expected delay information of the repeater entity. This may also further correspond to the LOS/NLOS determination from one or multiple paths arising from different elements within a RIS array. If LOS is disrupted, the expected delay pattern will also disappear, hence, a healthy delay pattern may serve as a verification of the LOS condition between the RIS and the UE. The measurement configuration can also include an estimation of the relative angle to the repeater entity (e.g., for the DoA and/or AoA estimation), and the UE estimates the angular information from the repeater entity, among others (e.g., additional angular analysis, prior angular knowledge), based on the measured RS delay received from the repeater entity. Depending on the UE angle, the delay spread or pattern experienced from the repeater will be different, and therefore can be used as a side information for angular estimation. The measurement configuration can also include an indication to classify or identify the propagation paths between a transmitter and the receiver that associates a direct or LOS path, non-repeater NLOS paths, and one or multiple repeater paths.

In implementations, the network configures each of one or multiple RISs, one or multiple RIS element groups, one or multiple NCRs, one or multiple IAB nodes, or a combination thereof with a configuration for a path signature, including a delay pattern and/or an angular pattern, based on which of the receivers performs the one or multiple of measurements according to the second configuration. In some embodiments, the modification includes a modification of the amplification and reflection phase, amplification amplitude, according to a time pattern. In some embodiments, the time-pattern (e.g., the symbols corresponding to each phase and/or amplitude modification) as well as the channel phase modification is indicated to the receiver, as part of the second configuration. The network can transmit to a receiving device (e.g., repeater devices) a signal generating configuration as part of the indication of the propagation pattern to the receiving device. In implementations, the signal generating configuration can include a delay pattern, an angular pattern, a time pattern, and/or a phase shift pattern associated with at least one of a delay, angle, or phase shift of a transmitted signal. In some implementations, a first phase time pattern is indicated to the RIS associated to a first reflection configuration (e.g., including mapping of the incident angles to the reflection angles of the RIS), whereas a second time pattern is associated to a phase rotation pattern (e.g., as a uniform phase shift of all RIS elements (or a subset of RIS elements) at each time-instance). In an implementation, the RIS is configured for the first subframe to reflect an angular incident A to a reflection angle of B, while at the same time, is configured to rotate the phase of all elements with a pattern of 45 degree * symbol number within the NR frame, where the phase rotation of all elements are changed in each symbol according to the above indicated pattern.

In implementations with reference to reporting configuration, a UE is configured via a reporting configuration to generate and transmit a report to the network, based on the performed measurements and according to the received reporting configuration. In some implementations, the reporting configuration includes time and frequency resources for the transmission of the measurement report, based on the measurements obtained, at least in part, based on the received delay information of the repeater entity, the reporting information (e.g., the one or multiple estimated ToAs and/or ToFs), and a reporting criterion (e.g., reporting of the obtained measurement if the LOS or NLOS condition is determined between the UE and the repeater entity).

In implementations, the network obtains the information on the characteristics of the repeater entity, such as part of the capability information received by the network from the repeater entity. Based on the obtained characteristics, the network determines the first, second, and/or third configurations for a UE and communicates the determined configurations. In an implementation, the network (e.g., gNB or LMF server) obtains the capability elements associated with a RIS, including the number, size, and type of the reflective elements, the topological arrangement of the reflector elements, the RIS dimensions and RIS orientations, and reflection strategy of the RIS (e.g., a subgroup of elements associated to a specific angular reflection), or a combination thereof. According to the obtained information on the repeater entity, the network determines the expected delay pattern associated with the reflection from the RIS for a UE, or indicates to the UE a subset of the obtained RIS information based on which the UE determines the expected delay pattern associated with the RIS reflection.

In implementations with reference to signaling, any of the RS, configurations or indications, and/or reporting within the above described implementations (or a subset, combination thereof) are received by the UE node(s), transmitted by the UE node(s), received by the repeater entity, transmitted by the repeater entity, transmitted and/or received by a RAN node (e.g., a gNB), or any combination thereof, via the uplink (UL), downlink (DL), or sidelink (SL) physical data and/or control channels defined within the communication network, e.g., NR physical broadcast channel (PBCH), physical downlink shared channel (PDSCH), physical downlink control channel (PDCCH), physical uplink shared channel (PUSCH), physical uplink control channel (PUCCH), physical sidelink broadcast channel (PSBCH), physical sidelink control channel (PSCCH), and physical sidelink shared channel (PSSCH).

In implementations, any one or more of the configurations and/or indications, or part of the information elements is communicated via RRC or higher layer signaling, such as LTE positioning protocol (LPP). In some implementations, one or multiple of the configurations and/or indications, or part of information elements is communicated between the network and the UE via a node-specific downlink control information (DCI), a group-common DCI, or a broadcast or a multicast message. In some implementations, different configurations, indications, and/or different information elements within one configuration is communicated via different signaling means. In some implementations, one or multiple of the configurations and/or indications, or part of the information elements is communicated via non-access stratum (NAS) signaling exchange between a core network entity or function and the UE (e.g., receiver), the repeater entity, a gNB or RAN node, or a combination thereof.

In aspects of repeater signal pattern as assisting information as described herein, UE positioning with delay and/or angle information assistance can be utilized. In an implementation, the position of a UE is obtained, at least in part, based on the measurements of the positioning reference signal (PRS) (or other RS) received in DL and/or measurements of the sounding reference signal (SRS) (or other RS) received in the UL, where the measurements are based on, at least in part, the delay and/or angular pattern information of the path associated with the repeater entity.

In implementations with reference to positioning at a UE, the UE position is estimated or computed at the UE, also referred to as UE-based positioning. The DL PRS (or other RS in the DL or in the SL) measurements are utilized at the UE, with the assistance of the delay pattern associated with the repeater entity as the side information. In some implementations, the ToA and/or ToF is estimated at the UE utilizing the side information (e.g., as the smallest of ToA and/or ToF values), as the ToA and/or ToF value associated with the strongest received RS, as the average of ToA and/or ToF values, a weighted average of the ToF and/or ToA values, the mean of the ToA and/or ToF values, or any indicated function (e.g. an indicated AI or ML model to compute the ToF and/or ToA from the received measurements and the delay and/or angle pattern associated to the repeater entity) of the ToA and/or ToF values associated with the repeater entity path. The obtained ToA and/or ToF is then used as an input for the triangulation at the UE. In alternate implementations, the DL-TDOA is estimated at the UE associated to a LOS path from one or multiple transmitter nodes (e.g., a gNB transmitting a PRS or other RS) and the reflection path from a repeater entity, based on the indicated delay information, corresponding to the PRS transmission from each TRP and/or gNB. In an implementation, the TDOA is estimated according to the difference of the ToA estimate at the LOS path and the ToA estimate from the repeater entity as the average of the measured ToA from the repeater entity.

In implementations, the UE position is estimated at the LMF (also referred to as UE-assisted positioning), based on, among others, the UE, gNB, RAN node report of the performed UE, gNB, RAN node measurements, where the measurements are based on, at least partially, the information of the delay pattern associated with the repeater entity. In some implementations, the UE, gNB, RAN node report includes, among others, one or multiple measurements as listed above, the estimation of the UE relative angle to the repeater entity, the LOS and/or NLOS determination of the UE, gNB, RAN node with respect to the repeater entity, the ToA and/or ToF estimation of the received RS from the path associated with the repeater entity, multiple ToA and/or ToF estimation of multiple rays associated with the repeater entity, the TDOA estimation at a path associated with the repeater entity and another indicated path, or any combination thereof. In implementations, the LMF obtains information on the capability and/or characteristics of the repeater entity, based at least partially on which the LMF determines the first, second, an third configurations for the UE node and/or performs a location estimation of the UE.

In implementations, the UE estimates the reception time of a first RS transmitted by a second UE, a gNB, or a RAN node based on, at least partially, the received information of the delay pattern associated with the repeater entity. In implementations, according to the estimated first RS reception time, the UE performs transmission of a second RS according to a received configuration. The configuration for the transmission of the second RS includes an indication of a delay period between the estimated reception time of the first RS and the transmission time of the second RS by the UE. The transmission of a first RS by another UE, gNB, or RAN node, the UE estimation of the RS reception time, and transmission of a second RS can be performed as part of an RTT estimation between the UE and a second UE, gNB, or RAN node. With reference to RTT positioning, other implementations can be added by changing the sequence of the RTT, or the number of the RTT iterations.

In aspects of repeater signal pattern as assisting information as described herein, object detection and positioning with delay information can be utilized. In an implementation, a radio sensing controller entity configures a sensing Rx node with a first configuration regarding the transmission of a sensing RS signal by a sensing Tx node, to be received and processed by the sensing Rx node; a second configuration for obtaining information of the propagation delay pattern and/or angular pattern induced to the RS via a repeater entity; a third configuration for the expected receiver signal processing and/or measurements of the received sensing RS, based on, among others, information of the delay pattern associated to the repeater entity; and/or a fourth configuration for the transmission of a report from the performed sensing processing according to the received first, second, and third configurations. The sensing Rx node can then perform the reception of the sensing RS, obtain information of the delay of the path associated with the repeater entity, perform respective radio sensing measurement and processing according to the received first, second, third configurations, and subsequently generate and transmit a report, according to the received fourth configuration.

In implementations, the radio sensing controller entity (e.g., a core network corresponding to LMF for sensing, or part of the RAN), can be or operate as part of a third-party application on a UE device, a RAN node (e.g., a gNB, a smart repeater, a IAB node, a UE or gNB-RSU), or operate as part of a core network entity (e.g., a radio sensing management function). In implementations, the set of sensing Rx nodes associated with a radio sensing scenario may include UE devices, gNB nodes, UE and/or gNB-RSU nodes, smart repeaters, IAB nodes, or any combination thereof. Further, the sensing controller entity obtains information on the capability and/or characteristics of the repeater entity, based at least partially on which the sensing controller entity determines the first, second, third, and fourth configurations (or any combination of the configurations thereof) for the sensing Rx node and/or performs processing and obtaining sensing information based on the obtained report and the obtained information on the capability and/or characteristics of the repeater entity.

In implementations, the configuration of the sensing measurements and signal processing includes determination of the LOS and/or NLOS condition, an object blockage condition, and/or object presence and detection between the sensing Tx node and the repeater entity, between the repeater entity and the sensing Rx node, or a combination thereof, where the determination of the object, blockage, LOS and/or NLOS condition is based at least in part on the obtained information of the delay pattern associated with the repeater entity. In an implementation, the blockage condition is detected, based on the received RS power and the obtained delay pattern associated to the repeater path, where the observation of an expected delay pattern indicates presence of the LOS and a no-blockage condition. In another implementation, a RIS is configured to reflect a particular incident angular region towards a sensing Rx node, where a sensing Tx node radiates RS towards the area.

The presence of an object within an area of interest is detected via hypothesis testing at the sensing Rx node measurements of the RSRP at the relevant delay margin to the area of interest for sensing. In other implementations, the object may be detected using a set of AI and/or ML tools or algorithms, which utilize the sensing Rx node measurements. The relevant delay margin to the area of interest for sensing is determined at the sensing Rx node based on, among others, the information on the delay pattern associated with the repeater entity. Upon detection of an object as being present within the area of interest for sensing, the shape and/or size of the object is estimated at the sensing Rx node, or at the sensing controller entity via the received report from the sensing Rx node, by compensating the effect of the additional delay caused due to the repeater entity on the rays reflected from the object.

In aspects of repeater signal pattern as assisting information as described herein, communication enhancements with delay and angle information assistance can be utilized. In an implementation, the obtained information on the delay pattern at a repeater entity is utilized by a UE for the reception of a physical channel (in the DL, SL); utilized by a UE for the transmission of a physical channel (in the UL, SL); utilized by a gNB or RAN node for the transmission of a DL physical channel or transmission among the RAN nodes (e.g., wireless backhaul transmission); and/or utilized by a gNB or RAN node for the reception of an UL physical channel or reception from another RAN node (e.g., wireless backhaul reception), where the physical channel communication is established with the impact of the repeater entity (e.g., via a reflection path from a RIS, or a path including an RF repeater or an IAB node).

In implementations, the receiver node performs CSI measurements based on, among others, the received RS and the obtained information on the delay pattern at a repeater entity. In an implementation, the RSRP is measured and/or reported as the collective power of the RS receptions from the delay margin associated with the repeater link. In implementations, usage of the delay information can include CSI estimated assistance at the UE, equalization and/or demodulation at the UE, and/or the network or gNB selects a demodulation density based on the information.

In implementations, the knowledge of the delay pattern at a repeater entity can be utilized to equalize the experienced channel (e.g., via a RAKE receiver (radio receiver)) and/or obtain a demodulation strategy based on the received DMRS, as well as the information on the delay pattern. Further, the network and/or a RAN node can configure the physical channel parameters (e.g., DMRS type and DMRS density, among others) based on the knowledge of the delay and/or angle pattern at the repeater entity. The delay pattern can also provide information regarding impaired RIS elements, which in-turn, can be reported to the network node for maintenance purposes.

In aspects of repeater signal pattern as assisting information as described herein, measurement-based delay and angle profile acquisition can be utilized. In an implementation, the information on the delay pattern of the repeater entity can be obtained based on the measurement of a UE, gNB, and/or RAN node for at least two instances of RS reception, such that at least on one of the RS measurements, the impact of the signal path from the repeater entity does not exist. In an implementation, the UE is indicated to perform RS measurement based on the transmitted RS (e.g., PRS or sensing RS) by the gNB, within for the first instance of RS transmission, the RIS does not reflect the transmitted RS towards the UE (based on a reflection strategy configured for the RIS at the particular resources associated with the first RS instance). This can be seen as an off state of the repeater entity, thereby the UE may estimate the CSI and/or DL-PRS (e.g., delay profile, power delay profile, angle power delay profile, etc.) associated to the received RS without impact of the repeater entity. In the second instance, the repeater entity (e.g., RIS) is configured to reflect the second RS instance transmitted by the gNB towards the UE, thereby enabling the UE to perform CSI and/or DL-PRS measurement including the impact of the repeater entity. The CSI (e.g., delay pattern associated with the repeater path(s)) is then estimated based on, at least in part, the difference of the estimated CSIs at different instances. The position estimate can be computed based on, for example, the delay pattern associated with the one or more repeater path(s) positioning measurements based on the DL-PRS measurement.

In implementations, the obtained delay pattern, the UE location, and/or the relative UE location to the repeater entity is reported to the network, to the gNB, to the LMF, to the sensing controller entity, or any combination thereof. In implementations, the obtained delay pattern is reported to another (second) UE according to a received configuration, where the delay pattern is further utilized at the second UE for the measurements outlined in any of the implementations described above.

As detailed throughout this disclosure for repeater signal pattern as assisting information, an indication of a repeater-induced pattern can include indications of path propagation delay, angular modification, phase shift modification and/or amplitude modification, a time-pattern associated to one or multiple of the above, or any combination of the above, as assisting information for measurements to a receiver. The repeater device can include, but is not limited to, a NCR, a RIS, a reflector object, an IAB node, and/or any other type of repeater device. Further, this disclosure details determination of the equalization and/or demodulation strategy, according to the information of the repeater-induced delay and/or angular pattern in a physical data and/or control channel in DL, UL, and/or SL.

Additionally, this disclosure details configuration of measurements and reporting of one or multiple of the CSI, RSRP, RSRP Path, ToA, ToF, TdoA, AoA, propagation path association to a repeater entity, as well as a LOS or NLOS condition at a receiver associated with a repeater link utilizing the repeater-induced delay and/or angular pattern information, in the context of a radio sensing operation a target device (the receiver node) positioning, or a combination thereof. This includes, but is not limited to, a computation of the ToF and/or ToA as an average or weighted average of the received path ToF and/or ToA, according to the information of the repeater path delay pattern; a computation of the angle of arrival as an average or weighted average of the received path angle according to the information of the repeater angle pattern; and path classification and/or identification based on the information of the time, delay, angle, and/or phase shift pattern of a repeater entity.

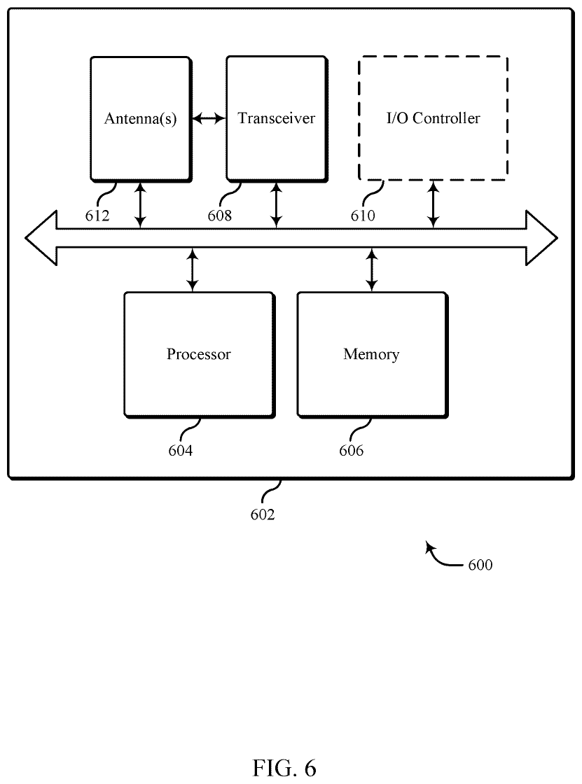

FIG. 6 illustrates an example of a block diagram 600 of a device 602 that supports repeater signal pattern as assisting information in accordance with aspects of the present disclosure. The device 602 may be an example of a network entity 102, such as a base station, RIS, RAN node, LMF, IAB node, and/or other type of network entity, as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. The processor 604 may be configured as or otherwise support a means for transmitting a first signaling indicating a receive configuration for reception of a reference signal by a receiving device; transmitting a second signaling indicating estimated signal configuration information including a propagation pattern of the reference signal attributable to one or more repeater devices; and transmitting a third signaling indicating a measurement configuration of the reference signal received according to the receive configuration and based at least in part on the estimated signal configuration information.

Additionally, the processor 604 may be configured as or otherwise support any one or combination of the propagation pattern of the reference signal includes at least one of a delay pattern, an angular pattern, a time pattern, a phase shift pattern, or an amplification pattern attributable to the one or more repeater devices. The method further comprising transmitting a fourth signaling indicating a configuration to obtain the estimated signal configuration information including at least one of: time-frequency resources for receiving propagation pattern information; one or more of data types or data type values associated with the propagation pattern information; or a data format associated with the propagation pattern information. The data types include one or more of a delay value indicating a fixed delay or an average delay caused by one of a reflection or an amplification of the reference signal at the one or more repeater devices; a range of delay values associated with the reflection or the amplification of the reference signal from the one or more repeater devices; one of a delay spread or a delay variance associated with the reflection or the amplification of the reference signal from the one or more repeater devices; a probability mass function indicating a delay pattern caused by the one or more repeater devices; at least one of one or more angle values, an angular value range, or a probability mass function over multiple angle values of the reference signal according to a coordinate system associated with the one or more repeater devices; at least one of energy values or amplification values of the reference signal associated with respective delay points and the one or more angle values; or a joint pattern of delay, angle, and energy associated with the one or more repeater devices. The data types include reciprocity mismatch information of at least one repeater device of the one or more repeater devices, the reciprocity mismatch information indicating one or more of a time period for which the propagation pattern remains valid; at least one of a reception, incident angle, or angular region for which the propagation pattern remains valid; or a difference between propagation patterns between two time periods, between two reception angular regions, or jointly for a time period and an angular region. The data types include one or more of dimensions of a repeater device of the one or more repeater devices, location information indicating a location of the repeater device, information indicating a shape of the repeater device, or an orientation of the repeater device. A repeater device of the one or more repeater devices is a RIS and the data types include one or more of dimensions of the RIS, a quantity of reflector elements of the RIS, or arrangement information indicating positioning of the reflector elements, the arrangement information including element spacing of the reflector elements. The data types include one or more of a channel phase shift pattern, an amplitude modification pattern, or multiple time patterns associated with at least one of the channel phase shift pattern or the amplitude modification pattern. The receive configuration for the reception of the reference signal includes one or more of at least one of a location or a velocity of a transmitter device; a transmission radiation pattern of the transmitter device; at least one of a waveform type of the reference signal or a set of waveform-defining parameters according to which the reference signal is transmitted; a set of resources over which the reference signal is transmitted according to at least one of the waveform type or the set of waveform-defining parameters; a transmit power according to which the reference signal is transmitted; or a sequence generation and physical-resource-mapping type based on which the reference signal is generated. The measurement configuration includes one or more of: at least one of a ToA estimation or a ToF estimation; at least one of a DoA estimation or an AoA estimation; an estimated TDOA for a signal path associated with a repeater device of the one or more repeater devices and another indicated signal path; or an estimated relative angle of the signal path to the repeater device. The method further comprising transmitting, to the one or more repeater devices, a fourth signaling indicating a signal generating configuration that includes at least one of a delay pattern, an angular pattern, a time pattern, or a phase shift pattern associated with at least one of a delay, angle, or phase shift of a transmitted signal. The measurement configuration includes one or more of: at least one of a determined LOS condition or a NLOS condition of a propagation path, an association of the propagation path or a CSI measurement to a repeater device of the one or more repeater devices or to a path not associated to the repeater device, an association of the propagation path or a CSI measurement to the repeater device, or the association of the propagation path or the CSI measurement to a path not associated with the repeater device, based at least in part on the phase shift of the transmitted signal, an amplitude modification pattern, or multiple time patterns associated with phase shift patterns and amplitude patterns of the one or more repeater devices. The estimated signal configuration includes one or more of a threshold of a received power value or received power measurements. The measurement configuration includes one or more of a CSI estimation of a propagation path associated with a repeater device of the one or more repeater devices; a type of the CSI estimation of the propagation path; an indication of a detected object; a first estimation of at least one of a device position or a device velocity; or a second estimation of at least one of an object position, an object velocity, or an object size. A repeater device of the one or more repeater devices is at least one of a network-controlled repeater, multiple network-controlled repeaters, a RIS, an IAB node, a sidelink relay node, or a reflector object. The method further comprising transmitting a fourth signaling indicating a reference signal transmission configuration to the receiving device, the reference signal transmission configuration including one or more of: at least one of a waveform type of the reference signal or a set of waveform-defining parameters according to which the reference signal is transmitted; a set of resources over which the reference signal is transmitted according to at least one of the waveform type or the set of waveform-defining parameters; at least one of a transmit beam pattern or a radiation pattern over which the reference signal is transmitted; a transmit power according to which the reference signal is transmitted; or a sequence generation and physical-resource-mapping type based on which the reference signal is generated. The method further comprising transmitting a fourth signaling indicating a reporting configuration that includes at least one of a set of time-frequency and beam resources for transmission of a report, a criterion for the transmission of the report, or an information type included in the report. The method further comprising transmitting a fourth signaling indicating a request for information of an induced propagation pattern that includes one or more of a delay-angular pattern, a delay pattern, an angular pattern, or a phase shift pattern from the one or more repeater devices. The method further comprising receiving, from the one or more repeater devices, a fifth signaling of the information including the induced propagation pattern of the one or more delay angular pattern, the delay pattern, the angular pattern, or the phase shift pattern. The method further comprising transmitting a fourth signaling indicating a reception configuration to obtain the propagation pattern of the reference signal of the one or more repeater devices; transmitting a fifth signaling indicating an operational state of the one or more repeater devices; and transmitting a sixth signaling indicating a signal measurement of a delay pattern and angle pattern of the one or more repeater devices. The method further comprising receiving a seventh signaling as a report of the signal measurement of the delay pattern and the angle pattern of the one or more repeater devices.

Additionally, or alternatively, the device 602, in accordance with examples as disclosed herein, may include a processor and a memory coupled with the processor, the processor configured to cause the apparatus to transmit a first signaling indicating a receive configuration for reception of a reference signal by a receiving device; transmit, to the receiving device, a second signaling indicating estimated signal configuration information including a propagation pattern of the reference signal attributable to one or more repeater devices; and transmit, to the receiving device, a third signaling indicating a measurement configuration of the reference signal received according to the receive configuration and based at least in part on the estimated signal configuration information.

Additionally, the wireless communication at the device 602 may include any one or combination of the propagation pattern of the reference signal includes at least one of a delay pattern, an angular pattern, a time pattern, a phase shift pattern, or an amplification pattern attributable to the one or more repeater devices. The processor is configured to cause the apparatus to transmit, to the receiving device, a fourth signaling indicating a configuration to obtain the estimated signal configuration information including at least one of time-frequency resources for receiving propagation pattern information; one or more of data types or data type values associated with the propagation pattern information; or a data format associated with the propagation pattern information. The data types include one or more of a delay value indicating a fixed delay or an average delay caused by one of a reflection or an amplification of the reference signal at the one or more repeater devices; a range of delay values associated with the reflection or the amplification of the reference signal from the one or more repeater devices; one of a delay spread or a delay variance associated with the reflection or the amplification of the reference signal from the one or more repeater devices; a probability mass function indicating a delay pattern caused by the one or more repeater devices; one or more angle values of the reference signal according to a coordinate system associated with the one or more repeater devices; at least one of energy values or amplification values of the reference signal associated with respective delay points and the one or more angle values; or a joint pattern of delay, angle, and energy associated with the one or more repeater devices. The data types include reciprocity mismatch information of at least one repeater device of the one or more repeater devices, the reciprocity mismatch information indicating one or more of a time period for which the propagation pattern remains valid; at least one of a reception, incident angle, or angular region for which the propagation pattern remains valid; or a difference between for a time period and an angular region. The data types include one or more of dimensions of a repeater device of the one or more repeater devices, location information indicating a location of the repeater device, information indicating a shape of the repeater device, or an orientation of the repeater device. A repeater device of the repeater devices is a RIS and the data types include one or more of dimensions of the RIS, a quantity of reflector elements of the RIS, or arrangement information indicating positioning of the reflector elements, the arrangement information including element spacing of the reflector elements. The data types include one or more of a channel phase shift pattern, an amplitude modification pattern, or multiple time patterns associated with at least one of the channel phase shift pattern or the amplitude modification pattern. The receive configuration for the reception of the reference signal includes one or more of: at least one of a location or a velocity of a transmitter device; a transmission radiation pattern of the transmitter device; at least one of a waveform type of the reference signal or a set of waveform-defining parameters according to which the reference signal is transmitted; a set of resources over which the reference signal is transmitted according to at least one of the waveform type or the set of waveform-defining parameters; a transmit power according to which the reference signal is transmitted; or a sequence generation and physical-resource-mapping type based on which the reference signal is generated. The measurement configuration includes one or more of: at least one of a ToA estimation or a ToF estimation; at least one of a DoA estimation or an AoA estimation; an estimated TDOA for a signal path associated with a repeater device of the one or more repeater devices and another indicated signal path; or an estimated relative angle of the signal path to the repeater device. The processor is configured to cause the apparatus to transmit, to the one or more repeater devices, a fourth signaling indicating a signal generating configuration that includes at least one of a delay pattern, an angular pattern, a time pattern, or a phase shift pattern associated with at least one of a delay, angle, or phase shift of a transmitted signal. The measurement configuration includes one or more of: at least one of a determined LOS condition or a NLOS condition of a propagation path, an association of the propagation path or a CSI measurement to a repeater device of the one or more repeater devices or to a path not associated to the repeater device, an association of the propagation path or a CSI measurement to the repeater device, or the association of the propagation path or the CSI measurement to a path not associated with the repeater device, based at least in part on the phase shift of the transmitted signal, an amplitude modification pattern, or multiple time patterns associated with phase shift patterns and amplitude patterns of the one or more repeater devices. The estimated signal configuration includes one or more of a threshold of a received power value or received power measurements. The measurement configuration includes one or more of a CSI estimation of a propagation path associated with a repeater device of the one or more repeater devices; a type of the CSI estimation of the propagation path; an indication of a detected object; a first estimation of at least one of a device position or a device velocity; or a second estimation of at least one of an object position, an object velocity, or an object size. A repeater device of the one or more repeater devices is at least one of a network-controlled repeater, multiple network-controlled repeaters, a RIS, an IAB node, a sidelink relay node, or a reflector object. The processor is configured to cause the apparatus to transmit a fourth signaling indicating a reference signal transmission configuration to the receiving device, the reference signal transmission configuration including one or more of: at least one of a waveform type of the reference signal or a set of waveform-defining parameters according to which the reference signal is transmitted; a set of resources over which the reference signal is transmitted according to at least one of the waveform type or the set of waveform-defining parameters; at least one of a transmit beam pattern or a radiation pattern over which the reference signal is transmitted; a transmit power according to which the reference signal is transmitted; or a sequence generation and physical-resource-mapping type based on which the reference signal is generated. The processor is configured to cause the apparatus to transmit, to the receiving device, a fourth signaling indicating a reporting configuration that includes at least one of a set of time-frequency and beam resources for transmission of a report, a criterion for the transmission of the report, or an information type included in the report. The apparatus is one of a gNB, a RSU, a UE, a location server, or a sensing controller device. The processor is configured to cause the apparatus to transmit a fourth signaling indicating a request for information of an induced propagation pattern that includes one or more of a delay-angular pattern, a delay pattern, an angular pattern, or a phase shift pattern from the one or more repeater devices. The processor is configured to cause the apparatus to receive, from the one or more repeater devices, a fifth signaling of the information including the induced propagation pattern of the one or more delay-angular pattern, the delay pattern, the angular pattern, or the phase shift pattern. The processor is configured to cause the apparatus to transmit, to the receiving device, a fourth signaling indicating a reception configuration to obtain the propagation pattern of the reference signal of the one or more repeater devices; transmit, to the receiving device, a fifth signaling indicating an operational state of the one or more repeater devices; and transmit, to the receiving device, a sixth signaling indicating a signal measurement of a delay pattern and angle pattern of the one or more repeater devices. The processor is configured to cause the apparatus to receive a seventh signaling as a report of the signal measurement of the delay pattern and the angle pattern of the one or more repeater devices.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

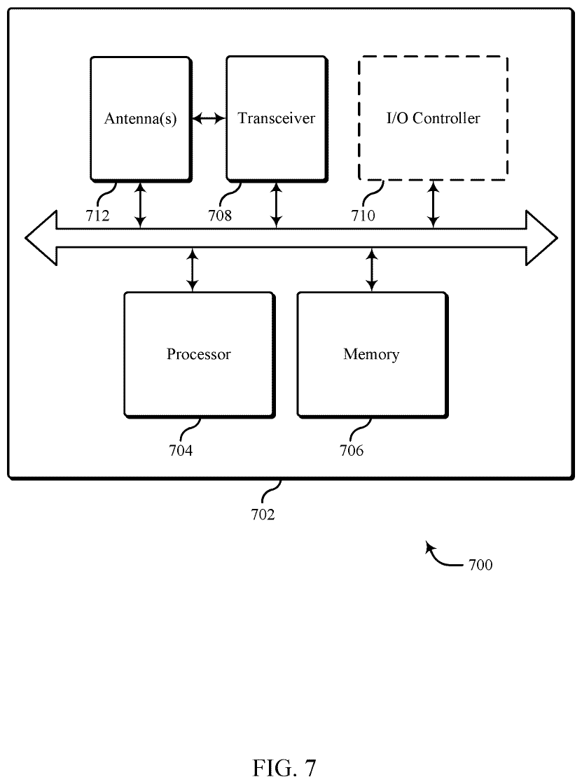

FIG. 7 illustrates an example of a block diagram 700 of a device 702 that supports repeater signal pattern as assisting information in accordance with aspects of the present disclosure. The device 702 may be an example of a UE 104 (e.g., receiving device), as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. The processor 704 may be configured as or otherwise support a means for receiving a first signaling indicating a receive configuration for reception of a reference signal; receiving a second signaling indicating estimated signal configuration information including a propagation pattern attributable to one or more repeater devices; receiving the reference signal according to the receive configuration; and receiving a third signaling indicating a measurement configuration of the reference signal based at least in part on the estimated signal configuration information.

Additionally, the processor 704 may be configured as or otherwise support any one or combination of the propagation pattern of the reference signal includes at least one of a delay pattern, an angular pattern, a time pattern, a phase shift pattern, or an amplification pattern attributable to the one or more repeater devices. The method further comprising receiving a fourth signaling indicating a configuration to obtain the estimated signal configuration information including at least one of time-frequency resources for receiving propagation pattern information; one or more of data types or data type values associated with the propagation pattern information; or a data format associated with the propagation pattern information. The data types include one or more of a delay value indicating a fixed delay or an average delay caused by one of a reflection or an amplification of the reference signal at the one or more repeater devices; a range of delay values associated with the reflection or the amplification of the reference signal from the one or more repeater devices; one of a delay spread or a delay variance associated with the reflection or the amplification of the reference signal from the one or more repeater devices; a probability mass function indicating a delay pattern caused by the one or more repeater devices; at least one of one or more angle values, an angular value range, or a probability mass function over multiple angle values of the reference signal according to a coordinate system associated with the one or more repeater devices; at least one of energy values or amplification values of the reference signal associated with respective delay points and the one or more angle values; or a joint pattern of delay, angle, and energy associated with the one or more repeater devices. The data types include reciprocity mismatch information of at least one repeater device of the one or more repeater devices, the reciprocity mismatch information indicating one or more of a time period for which the propagation pattern remains valid; at least one of a reception, incident angle, or angular region for which the propagation pattern remains valid; or a difference between propagation patterns between two time periods, between two reception angular regions, or jointly for a time period and an angular region. The data types include one or more of dimensions of a repeater device of the one or more repeater devices, location information indicating a location of the repeater device, information indicating a shape of the repeater device, or an orientation of the repeater device. A repeater device of the one or more repeater devices is a RIS and the data types include one or more of dimensions of the RIS, a quantity of reflector elements of the RIS or arrangement information indicating positioning of the reflector elements, the arrangement information including element spacing of the reflector elements. The data types include one or more of a channel phase shift pattern, an amplitude modification pattern, or multiple time patterns associated with at least one of the channel phase shift pattern or the amplitude modification pattern. The receive configuration for the reception of the reference signal includes one or more of: at least one of a location or a velocity of a transmitter device; a transmission radiation pattern of the transmitter device; at least one of a waveform type of the reference signal or a set of waveform-defining parameters according to which the reference signal is transmitted; a set of resources over which the reference signal is transmitted according to at least one of the waveform type or the set of waveform-defining parameters; a transmit power according to which the reference signal is transmitted; or a sequence generation and physical-resource-mapping type based on which the reference signal is generated. The measurement configuration includes one or more of: at least one of a ToA estimation or a ToF estimation; at least one of a DoA estimation or an AoA estimation; an estimated TDOA for a signal path associated with a repeater device of the one or more repeater devices and another indicated signal path; or an estimated relative angle of the signal path to the repeater device. The method further comprising receiving, from the one or more repeater devices, a fourth signaling indicating a signal generating configuration that includes at least one of a delay pattern, an angular pattern, a time pattern, or a phase shift pattern associated with at least one of a delay, angle, or phase shift of a transmitted signal. The measurement configuration includes one or more of: at least one of a determined LOS condition or a NLOS condition of a propagation path, an association of the propagation path or a CSI measurement to a repeater device or the one or more repeater devices or to a path not associated to the repeater device, an association of the propagation path or a CSI measurement to the repeater device, or the association of the propagation path or the CSI measurement to a path not associated with the repeater device, based at least in part on the phase shift of the transmitted signal, an amplitude modification pattern, or multiple time patterns associated with phase shift patterns and amplitude patterns of the one or more repeater devices. The estimated signal configuration includes one or more of a threshold of a received power value or received power measurements. The measurement configuration includes one or more of a CSI estimation of a propagation path associated with a repeater device of the one or more repeater devices; a type of the CSI estimation of the propagation path; an indication of a detected object; a first estimation of at least one of a device position or a device velocity; or a second estimation of at least one of an object position, an object velocity, or an object size. The repeater device is at least one of a network-controlled repeater, multiple network-controlled repeaters, a RIS, an IAB node, a sidelink relay node, or a reflector object. The method further comprising receiving a fourth signaling indicating a reference signal transmission configuration for a receiving device, the reference signal transmission configuration including one or more of: at least one of a waveform type of the reference signal or a set of waveform-defining parameters according to which the reference signal is transmitted; a set of resources over which the reference signal is transmitted according to at least one of the waveform type or the set of waveform-defining parameters; at least one of a transmit beam pattern or a radiation pattern over which the reference signal is transmitted; a transmit power according to which the reference signal is transmitted; or a sequence generation and physical-resource-mapping type based on which the reference signal is generated. The method further comprising receiving a fourth signaling indicating a reporting configuration that includes at least one of a set of time-frequency and beam resources for transmission of a report, a criterion for the transmission of the report, or an information type included in the report. The method further comprising receiving a fourth signaling indicating a reception configuration to obtain the propagation pattern of the reference signal of the one or more repeater devices; receiving a fifth signaling indicating an operational state of the one or more repeater devices; and receiving a sixth signaling indicating a signal measurement of a delay pattern and angle pattern of the one or more repeater devices. The method further comprising transmitting a seventh signaling as a report of the signal measurement of the delay pattern and the angle pattern of the one or more repeater devices.

Additionally, or alternatively, the device 702, in accordance with examples as disclosed herein, may include a processor and a memory coupled with the processor, the processor configured to cause the apparatus to receive a first signaling indicating a receive configuration for reception of a reference signal; receive a second signaling indicating estimated signal configuration information including a propagation pattern attributable to one or more repeater devices; receive the reference signal according to the receive configuration; and receive a third signaling indicating a measurement configuration of the reference signal based at least in part on the estimated signal configuration information.

Additionally, the wireless communication at the device 702 may include any one or combination of the propagation pattern of the reference signal includes at least one of a delay pattern, an angular pattern, a time pattern, a phase shift pattern, or an amplification pattern attributable to the one or more repeater devices. The processor is configured to cause the apparatus to receive a fourth signaling indicating a configuration to obtain the estimated signal configuration information including at least one of time-frequency resources for receiving propagation pattern information; one or more of data types or data type values associated with the propagation pattern information; or a data format associated with the propagation pattern information. The data types include one or more of a delay value indicating a fixed delay or an average delay caused by one of a reflection or an amplification of the reference signal at the one or more repeater devices; a range of delay values associated with the reflection or the amplification of the reference signal from the one or more repeater devices; one of a delay spread or a delay variance associated with the reflection or the amplification of the reference signal from the one or more repeater devices; a probability mass function indicating a delay pattern caused by the one or more repeater devices; at least one of one or more angle values, an angular value range, or a probability mass function over multiple angle values of the reference signal according to a coordinate system associated with the one or more repeater devices; at least one of energy values or amplification values of the reference signal associated with respective delay points and the one or more angle values; or a joint pattern of delay, angle, and energy associated with the one or more repeater devices. The data types include reciprocity mismatch information of at least one repeater device of the one or more repeater devices, the reciprocity mismatch information indicating one or more of a time period for which the propagation pattern remains valid; at least one of a reception, incident angle, or angular region for which the propagation pattern remains valid; or a difference between propagation patterns between two time periods, between two reception angular regions, or jointly for a time period and an angular region. The data types include one or more of dimensions of a repeater device of the one or more repeater devices, location information indicating a location of the repeater device, information indicating a shape of the repeater device, or an orientation of the repeater device. A repeater device of the one or more repeater devices is a RIS and the data types include one or more of dimensions of the RIS, a quantity of reflector elements of the RIS, or arrangement information indicating positioning of the reflector elements, the arrangement information including element spacing of the reflector elements. The data types include one or more of a channel phase shift pattern, an amplitude modification pattern, or multiple time patterns associated with at least one of the channel phase shift pattern or the amplitude modification pattern. The receive configuration for the reception of the reference signal includes one or more of: at least one of a location or a velocity of a transmitter device; a transmission radiation pattern of the transmitter device; at least one of a waveform type of the reference signal or a set of waveform-defining parameters according to which the reference signal is transmitted; a set of resources over which the reference signal is transmitted according to at least one of the waveform type or the set of waveform-defining parameters; a transmit power according to which the reference signal is transmitted; or a sequence generation and physical-resource-mapping type based on which the reference signal is generated. The measurement configuration includes one or more of: at least one of a ToA estimation or a ToF estimation; at least one of a DoA estimation or an AoA estimation; an estimated TDOA for a signal path associated with a repeater device of the one or more repeater devices and another indicated signal path; or an estimated relative angle of the signal path to the repeater device. The processor is configured to cause the apparatus to receive, from the one or more repeater devices, a fourth signaling indicating a signal generating configuration that includes at least one of a delay pattern, an angular pattern, a time pattern, or a phase shift pattern associated with at least one of a delay, angle, or phase shift of a transmitted signal. The measurement configuration includes one or more of at least one of a determined LOS condition or a NLOS condition of a propagation path, an association of the propagation path or a CSI measurement to a repeater device of the one or more repeater devices or to a path not associated to the repeater device, an association of the propagation path or a CSI measurement to the repeater device, or the association of the propagation path or the CSI measurement to a path not associated with the repeater device, based at least in part on the phase shift of the transmitted signal, an amplitude modification pattern, or multiple time patterns associated with phase shift patterns and amplitude patterns of the one or more repeater devices. The estimated signal configuration includes one or more of a threshold of a received power value or received power measurements. The measurement configuration includes one or more of a CSI estimation of a propagation path associated with a repeater device of the one or more repeater devices; a type of the CSI estimation of the propagation path; an indication of a detected object; a first estimation of at least one of a device position or a device velocity; or a second estimation of at least one of an object position, an object velocity, or an object size. The repeater device is at least one of a network-controlled repeater, multiple network-controlled repeaters, a RIS, an IAB node, a sidelink relay node, or a reflector object. The processor is configured to cause the apparatus to receive a fourth signaling indicating a reference signal transmission configuration for a receiving device, the reference signal transmission configuration including one or more of: at least one of a waveform type of the reference signal or a set of waveform-defining parameters according to which the reference signal is transmitted; a set of resources over which the reference signal is transmitted according to at least one of the waveform type or the set of waveform-defining parameters; at least one of a transmit beam pattern or a radiation pattern over which the reference signal is transmitted; a transmit power according to which the reference signal is transmitted; or a sequence generation and physical-resource-mapping type based on which the reference signal is generated. The processor is configured to cause the apparatus to receive a fourth signaling indicating a reporting configuration that includes at least one of a set of time-frequency and beam resources for transmission of a report, a criterion for the transmission of the report, or an information type included in the report. The processor is configured to cause the apparatus to receive a fourth signaling indicating a reception configuration to obtain the propagation pattern of the reference signal of the one or more repeater devices; receive a fifth signaling indicating an operational state of the one or more repeater devices; and receive a sixth signaling indicating a signal measurement of a delay pattern and angle pattern of the one or more repeater devices. The processor is configured to cause the apparatus to transmit a seventh signaling as a report of the signal measurement of the delay pattern and the angle pattern of the one or more repeater devices.

The processor 704 of the device 702, such as a UE 104, may support wireless communication in accordance with examples as disclosed herein. The processor 704 includes at least one controller coupled with at least one memory, and is configured to or operable to cause the processor to receive a first signaling indicating a receive configuration for reception of a reference signal; receive a second signaling indicating estimated signal configuration information including a propagation pattern attributable to one or more repeater devices; receive the reference signal according to the receive configuration; and receive a third signaling indicating a measurement configuration of the reference signal based at least in part on the estimated signal configuration information.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device 702. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

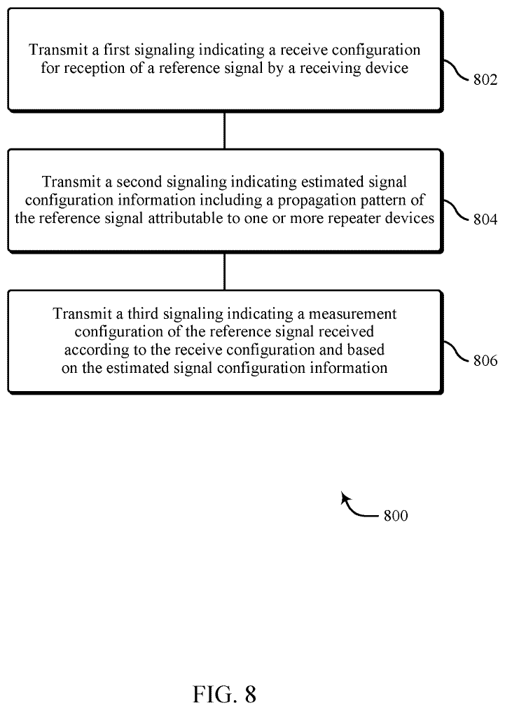

FIG. 8 illustrates a flowchart of a method 800 that supports repeater signal pattern as assisting information in accordance with aspects of the present disclosure. The operations of the method 800 may be implemented by a device or its components as described herein. For example, the operations of the method 800 may be performed by a network entity 102 (e.g., a base station) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include transmitting a first signaling indicating a receive configuration for reception of a reference signal by a receiving device. The operations of 802 may be performed in accordance with examples as described herein. In some implementations, aspects of the operations of 802 may be performed by a device as described with reference to FIG. 1.

At 804, the method may include transmitting a second signaling indicating estimated signal configuration information including a propagation pattern of the reference signal attributable to one or more repeater devices. The operations of 804 may be performed in accordance with examples as described herein. In some implementations, aspects of the operations of 804 may be performed by a device as described with reference to FIG. 1.

At 806, the method may include transmitting a third signaling indicating a measurement configuration of the reference signal received according to the receive configuration and based at least in part on the estimated signal configuration information. The operations of 806 may be performed in accordance with examples as described herein. In some implementations, aspects of the operations of 806 may be performed by a device as described with reference to FIG. 1.

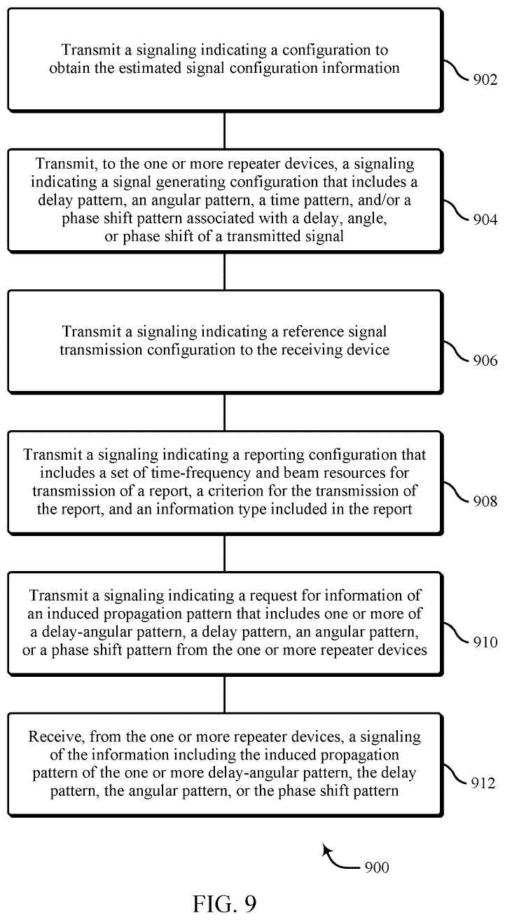

FIG. 9 illustrates a flowchart of a method 900 that supports repeater signal pattern as assisting information in accordance with aspects of the present disclosure. The operations of the method 900 may be implemented by a device or its components as described herein. For example, the operations of the method 900 may be performed by a network entity 102 (e.g., a base station) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include transmitting a signaling indicating a configuration to obtain the estimated signal configuration information. The estimated signal configuration information includes at least one of time-frequency resources for receiving propagation pattern information, data types and/or data type values associated with the propagation pattern information, or a data format associated with the propagation pattern information. The operations of 902 may be performed in accordance with examples as described herein. In some implementations, aspects of the operations of 902 may be performed by a device as described with reference to FIG. 1.

At 904, the method may include transmitting, to the one or more repeater devices, a signaling indicating a signal generating configuration that includes a delay pattern, an angular pattern, a time pattern, and/or a phase shift pattern associated with one of a delay, angle, or phase shift of a transmitted signal. The operations of 904 may be performed in accordance with examples as described herein. In some implementations, aspects of the operations of 904 may be performed by a device as described with reference to FIG. 1.

At 906, the method may include transmitting a signaling indicating a reference signal transmission configuration to the receiving device. The reference signal transmission configuration includes one or more of at least one of a waveform type of the reference signal or a set of waveform-defining parameters according to which the reference signal is transmitted; a set of resources over which the reference signal is transmitted according to at least one of the waveform type or the set of waveform-defining parameters; at least one of a transmit beam pattern or a radiation pattern over which the reference signal is transmitted; a transmit power according to which the reference signal is transmitted; or a sequence generation and physical-resource-mapping type based on which the reference signal is generated. The operations of 906 may be performed in accordance with examples as described herein. In some implementations, aspects of the operations of 906 may be performed by a device as described with reference to FIG. 1.

At 908, the method may include transmitting a signaling indicating a reporting configuration that includes a set of time-frequency and beam resources for transmission of a report, a criterion for the transmission of the report, and an information type included in the report. The operations of 908 may be performed in accordance with examples as described herein. In some implementations, aspects of the operations of 908 may be performed by a device as described with reference to FIG. 1.

At 910, the method may include transmitting a signaling indicating a request for information of an induced propagation pattern that includes one or more of a delay-angular pattern, a delay pattern, an angular pattern, or a phase shift pattern from the one or more repeater devices. The operations of 910 may be performed in accordance with examples as described herein. In some implementations, aspects of the operations of 910 may be performed by a device as described with reference to FIG. 1.

At 912, the method may include receiving, from the one or more repeater devices, a signaling of the information including the induced propagation pattern of the one or more delay-angular pattern, the delay pattern, the angular pattern, or the phase shift pattern. The operations of 912 may be performed in accordance with examples as described herein. In some implementations, aspects of the operations of 912 may be performed by a device as described with reference to FIG. 1.

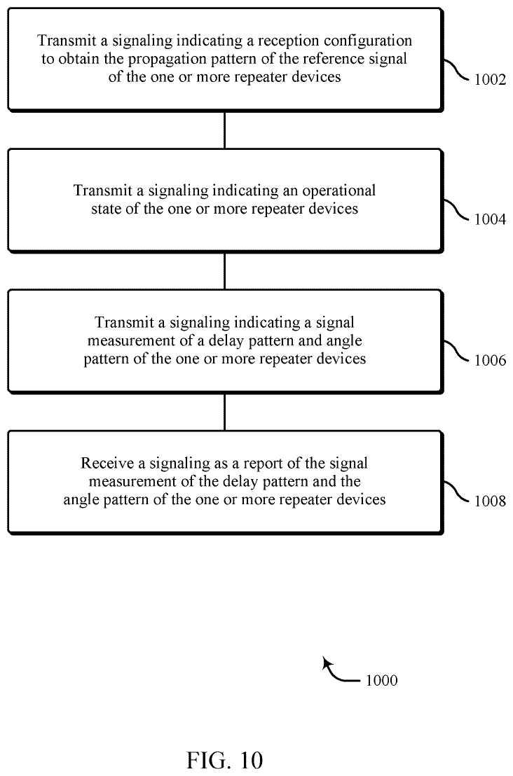

FIG. 10 illustrates a flowchart of a method 1000 that supports repeater signal pattern as assisting information in accordance with aspects of the present disclosure. The operations of the method 1000 may be implemented by a device or its components as described herein. For example, the operations of the method 1000 may be performed by a network entity 102 (e.g., a base station) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include transmitting a signaling indicating a reception configuration to obtain the propagation pattern of the reference signal of the one or more repeater devices. The operations of 1002 may be performed in accordance with examples as described herein. In some implementations, aspects of the operations of 1002 may be performed by a device as described with reference to FIG. 1.

At 1004, the method may include transmitting a signaling indicating an operational state of the one or more repeater devices. The operations of 1004 may be performed in accordance with examples as described herein. In some implementations, aspects of the operations of 1004 may be performed by a device as described with reference to FIG. 1.

At 1006, the method may include transmitting a signaling indicating a signal measurement of a delay pattern and angle pattern of the one or more repeater devices. The operations of 1006 may be performed in accordance with examples as described herein. In some implementations, aspects of the operations of 1006 may be performed by a device as described with reference to FIG. 1.

At 1008, the method may include receiving a signaling as a report of the signal measurement of the delay pattern and the angle pattern of the one or more repeater devices. The operations of 1008 may be performed in accordance with examples as described herein. In some implementations, aspects of the operations of 1008 may be performed by a device as described with reference to FIG. 1.

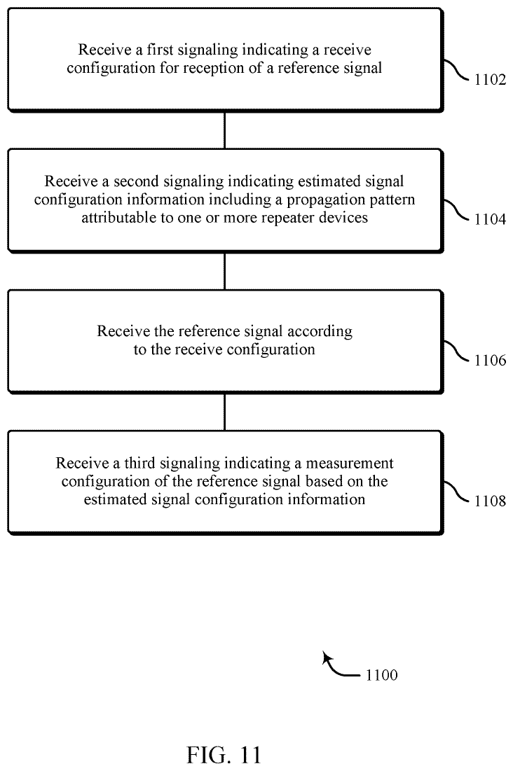

FIG. 11 illustrates a flowchart of a method 1100 that supports repeater signal pattern as assisting information in accordance with aspects of the present disclosure. The operations of the method 1100 may be implemented by a device or its components as described herein. For example, the operations of the method 1100 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1102, the method may include receiving a first signaling indicating a receive configuration for reception of a reference signal. The operations of 1102 may be performed in accordance with examples as described herein. In some implementations, aspects of the operations of 1102 may be performed by a device as described with reference to FIG. 1.

At 1104, the method may include receiving a second signaling indicating estimated signal configuration information including a propagation pattern attributable to one or more repeater devices. The operations of 1104 may be performed in accordance with examples as described herein. In some implementations, aspects of the operations of 1104 may be performed by a device as described with reference to FIG. 1.

At 1106, the method may include receiving the reference signal according to the receive configuration. The operations of 1106 may be performed in accordance with examples as described herein. In some implementations, aspects of the operations of 1106 may be performed by a device as described with reference to FIG. 1.

At 1108, the method may include receiving a third signaling indicating a measurement configuration of the reference signal based at least in part on the estimated signal configuration information. The operations of 1108 may be performed in accordance with examples as described herein. In some implementations, aspects of the operations of 1108 may be performed by a device as described with reference to FIG. 1.

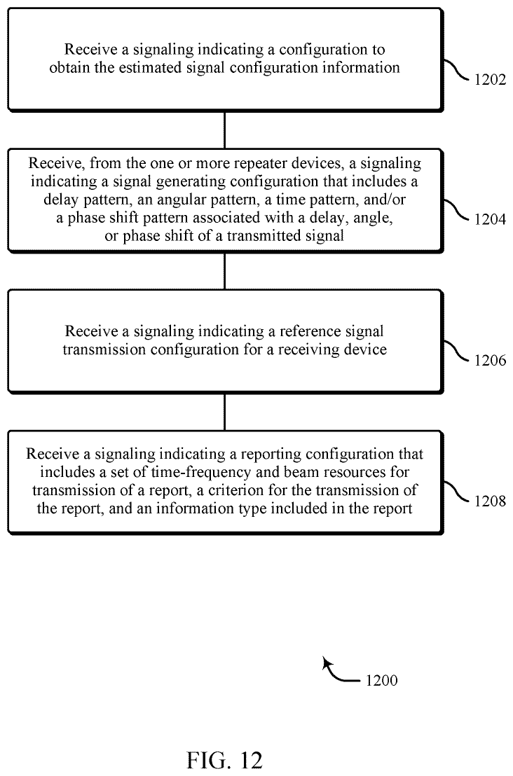

FIG. 12 illustrates a flowchart of a method 1200 that supports repeater signal pattern as assisting information in accordance with aspects of the present disclosure. The operations of the method 1200 may be implemented by a device or its components as described herein. For example, the operations of the method 1200 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1202, the method may include receiving a signaling indicating a configuration to obtain the estimated signal configuration information. The estimated signal configuration information includes time-frequency resources for receiving propagation pattern information, one or more of data types or data type values associated with the propagation pattern information, and/or a data format associated with the propagation pattern information. The operations of 1202 may be performed in accordance with examples as described herein. In some implementations, aspects of the operations of 1202 may be performed by a device as described with reference to FIG. 1.

At 1204, the method may include receiving, from the one or more repeater devices, a signaling indicating a signal generating configuration that includes a delay pattern, an angular pattern, a time pattern, and/or a phase shift pattern associated with a delay, angle, or phase shift of a transmitted signal. The operations of 1204 may be performed in accordance with examples as described herein. In some implementations, aspects of the operations of 1204 may be performed by a device as described with reference to FIG. 1.

At 1206, the method may include receiving a signaling indicating a reference signal transmission configuration for a receiving device. The reference signal transmission configuration includes one or more of at least one of a waveform type of the reference signal or a set of waveform-defining parameters according to which the reference signal is transmitted; a set of resources over which the reference signal is transmitted according to at least one of the waveform type or the set of waveform-defining parameters; at least one of a transmit beam pattern or a radiation pattern over which the reference signal is transmitted; a transmit power according to which the reference signal is transmitted; or a sequence generation and physical-resource-mapping type based on which the reference signal is generated. The operations of 1206 may be performed in accordance with examples as described herein. In some implementations, aspects of the operations of 1206 may be performed by a device as described with reference to FIG. 1.

At 1208, the method may include receiving a signaling indicating a reporting configuration that includes a set of time-frequency and beam resources for transmission of a report, a criterion for the transmission of the report, and an information type included in the report. The operations of 1208 may be performed in accordance with examples as described herein. In some implementations, aspects of the operations of 1208 may be performed by a device as described with reference to FIG. 1.

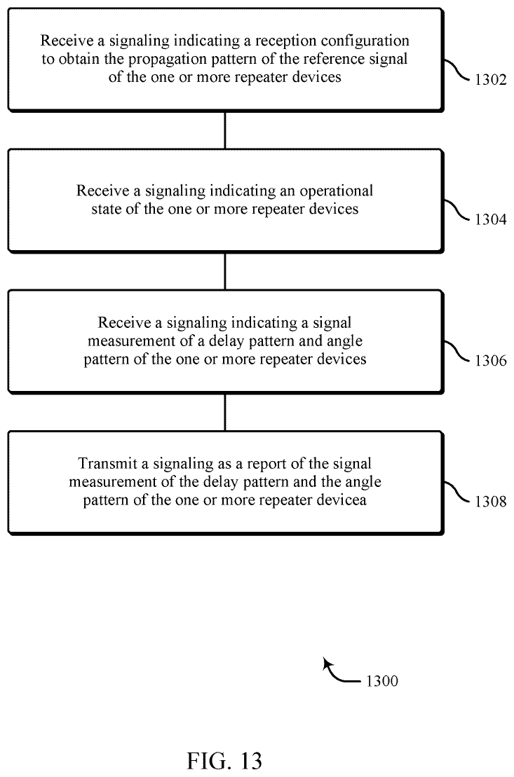

FIG. 13 illustrates a flowchart of a method 1300 that supports repeater signal pattern as assisting information in accordance with aspects of the present disclosure. The operations of the method 1300 may be implemented by a device or its components as described herein. For example, the operations of the method 1300 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1302, the method may include receiving a signaling indicating a reception configuration to obtain the propagation pattern of the reference signal of the one or more repeater devices. The operations of 1302 may be performed in accordance with examples as described herein. In some implementations, aspects of the operations of 1302 may be performed by a device as described with reference to FIG. 1.

At 1304, the method may include receiving a signaling indicating an operational state of the one or more repeater devices. The operations of 1304 may be performed in accordance with examples as described herein. In some implementations, aspects of the operations of 1304 may be performed by a device as described with reference to FIG. 1.

At 1306, the method may include receiving a signaling indicating a signal measurement of a delay pattern and angle pattern of the one or more repeater devices. The operations of 1306 may be performed in accordance with examples as described herein. In some implementations, aspects of the operations of 1306 may be performed by a device as described with reference to FIG. 1.

At 1308, the method may include transmitting a signaling as a report of the signal measurement of the delay pattern and the angle pattern of the one or more repeater devices. The operations of 1308 may be performed in accordance with examples as described herein. In some implementations, aspects of the operations of 1308 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A base station (BS) for wireless communication, comprising:
at least one memory; and
at least one processor coupled with the at least one memory and operable to cause the BS to:
transmit a first signaling indicating a receive configuration for reception of a reference signal by a receiving device;
transmit, to the receiving device, a second signaling indicating estimated signal configuration information including a propagation pattern of the reference signal attributable to one or more repeater devices; and
transmit, to the receiving device, a third signaling indicating a measurement configuration of the reference signal received according to the receive configuration and based at least in part on the estimated signal configuration information.

2. The BS of claim 1, wherein the propagation pattern of the reference signal includes at least one of a delay pattern, an angular pattern, a time pattern, a phase shift pattern, or an amplification pattern attributable to the one or more repeater devices.

3. The BS of claim 1, wherein the at least one processor is operable to cause the BS to transmit, to the receiving device, a fourth signaling indicating a configuration to obtain the estimated signal configuration information including at least one of:
time-frequency resources for receiving propagation pattern information;
one or more of data types or data type values associated with the propagation pattern information; or
a data format associated with the propagation pattern information.

4. The BS of claim 1, wherein the receive configuration for the reception of the reference signal includes one or more of:
at least one of a location or a velocity of a transmitter device;
a transmission radiation pattern of the transmitter device;
at least one of a waveform type of the reference signal or a set of waveform-defining parameters according to which the reference signal is transmitted;
a set of resources over which the reference signal is transmitted according to at least one of the waveform type or the set of waveform-defining parameters;
a transmit power according to which the reference signal is transmitted; or
a sequence generation and physical-resource-mapping type based on which the reference signal is generated.

5. The BS of claim 1, wherein the at least one processor is operable to cause the BS to transmit, to the one or more repeater devices, a fourth signaling indicating a signal generating configuration that includes at least one of a delay pattern, an angular pattern, a time pattern, or a phase shift pattern associated with at least one of a delay, angle, or phase shift of a transmitted signal.

6. The BS of claim 1, wherein the measurement configuration includes one or more of:
a channel state information (CSI) estimation of a propagation path associated with a repeater device of the one or more repeater devices;
a type of the CSI estimation of the propagation path;
an indication of a detected object;
a first estimation of at least one of a device position or a device velocity; or
a second estimation of at least one of an object position, an object velocity, or an object size.

7. The BS of claim 1, wherein the at least one processor is operable to cause the BS to transmit a fourth signaling indicating a reference signal transmission configuration to the receiving device, the reference signal transmission configuration including one or more of:
at least one of a waveform type of the reference signal or a set of waveform-defining parameters according to which the reference signal is transmitted;
a set of resources over which the reference signal is transmitted according to at least one of the waveform type or the set of waveform-defining parameters;
at least one of a transmit beam pattern or a radiation pattern over which the reference signal is transmitted;
a transmit power according to which the reference signal is transmitted; or
a sequence generation and physical-resource-mapping type based on which the reference signal is generated.

8. The BS of claim 1, wherein the at least one processor is operable to cause the BS to transmit, to the receiving device, a fourth signaling indicating a reporting configuration that includes at least one of a set of time-frequency and beam resources for transmission of a report, a criterion for the transmission of the report, or an information type included in the report.

9. The BS of claim 1, wherein the at least one processor is operable to cause the BS to transmit a fourth signaling indicating a request for information of an induced propagation pattern that includes one or more of a delay-angular pattern, a delay pattern, an angular pattern, or a phase shift pattern from the one or more repeater devices.

10. The BS of claim 1, wherein the at least one processor is operable to cause the BS to:
transmit, to the receiving device, a fourth signaling indicating a reception configuration to obtain the propagation pattern of the reference signal of the one or more repeater devices;
transmit, to the receiving device, a fifth signaling indicating an operational state of the one or more repeater devices; and
transmit, to the receiving device, a sixth signaling indicating a signal measurement of a delay pattern and angle pattern of the one or more repeater devices.

11. A user equipment (UE) for wireless communication, comprising:
at least one memory; and
at least one processor coupled with the at least one memory and configured operable to cause the UE to:
receive a first signaling indicating a receive configuration for reception of a reference signal;
receive a second signaling indicating estimated signal configuration information including a propagation pattern attributable to one or more repeater devices;
receive the reference signal according to the receive configuration; and
receive a third signaling indicating a measurement configuration of the reference signal based at least in part on the estimated signal configuration information.

12. The UE of claim 11, wherein the propagation pattern of the reference signal includes at least one of a delay pattern, an angular pattern, a time pattern, a phase shift pattern, or an amplification pattern attributable to the one or more repeater devices.

13. The UE of claim 11, wherein the at least one processor is operable to cause the UE to receive a fourth signaling indicating a configuration to obtain the estimated signal configuration information including at least one of:
time-frequency resources for receiving propagation pattern information;
one or more of data types or data type values associated with the propagation pattern information; or
a data format associated with the propagation pattern information.

14. The UE of claim 13, wherein a repeater device of the one or more repeater devices is a reconfigurable intelligent surface (RIS) and the data types include one or more of dimensions of the RIS, a quantity of reflector elements of the RIS, or arrangement information indicating positioning of the reflector elements, the arrangement information including element spacing of the reflector elements.

15. The UE of claim 13, wherein the data types include one or more of a channel phase shift pattern, an amplitude modification pattern, or multiple time patterns associated with at least one of the channel phase shift pattern or the amplitude modification pattern.

16. The UE of claim 11, wherein the receive configuration for the reception of the reference signal includes one or more of:
at least one of a location or a velocity of a transmitter device;
a transmission radiation pattern of the transmitter device;
at least one of a waveform type of the reference signal or a set of waveform-defining parameters according to which the reference signal is transmitted;
a set of resources over which the reference signal is transmitted according to at least one of the waveform type or the set of waveform-defining parameters;
a transmit power according to which the reference signal is transmitted; or
a sequence generation and physical-resource-mapping type based on which the reference signal is generated.

17. The UE of claim 11, wherein the at least one processor is operable to cause the UE to receive, from the one or more repeater devices, a fourth signaling indicating a signal generating configuration that includes at least one of a delay pattern, an angular pattern, a time pattern, or a phase shift pattern associated with at least one of a delay, angle, or phase shift of a transmitted signal.

18. The UE of claim 11, wherein the at least one processor is operable to cause the UE to receive a fourth signaling indicating a reporting configuration that includes at least one of a set of time-frequency and beam resources for transmission of a report, a criterion for the transmission of the report, or an information type included in the report.

19. (canceled)

20. A method performed by a base station (BS), the method comprising:
transmitting a first signaling indicating a receive configuration for reception of a reference signal by a receiving device;
transmitting a second signaling indicating estimated signal configuration information including a propagation pattern of the reference signal attributable to one or more repeater devices; and
transmitting a third signaling indicating a measurement configuration of the reference signal received according to the receive configuration and based at least in part on the estimated signal configuration information.

21. A method performed by a user equipment (UE), the method comprising:
receiving a first signaling indicating a receive configuration for reception of a reference signal;
receiving a second signaling indicating estimated signal configuration information including a propagation pattern attributable to one or more repeater devices;
receiving the reference signal according to the receive configuration; and
receiving a third signaling indicating a measurement configuration of the reference signal based at least in part on the estimated signal configuration information.
